(19) United States
(12) Patent Application Publication
(10) Pub. No.: US 2026/0250473 A1
(43) Pub. Date: Aug. 27, 2026

(54) METHOD OF FORMING AN EMULSION USING A PERFORATED PADDLE

(71) Applicant: AXALTA COATING SYSTEMS IP CO., LLC, Wilmington, DE (US)

(72) Inventors: Cen Lin, Claymont, DE (US); Mei Wen, Chesterbrook, PA (US); Carmen Flosbach, Wuppertal (DE); David Vincent Schiavi, Logan Township, NJ (US)

(73) Assignee: AXALTA COATING SYSTEMS IP CO., LLC, Wilmington, DE (US)

(21) Appl. No.: 19/448,463

(22) Filed: Jan. 14, 2026

Related U.S. Application Data
(60) Provisional application No. 63/764,108, filed on Feb. 27, 2025.

(51) Int. Cl. C08J 3/26; C08L 33/06

(52) U.S. Cl. CPC C08J 3/26; C08L 33/066; C08J 2333/10; C08J 2467/00

(57) ABSTRACT

A method of forming an emulsion (162) includes the steps of providing a resin having a cross-linkable group, water and a paddle (100); and mixing the resin, the crosslinker; and the water with the paddle (100) to form the emulsion (162) wherein the emulsion (162) includes a plurality of hydrophobic droplets having a particle size distribution Dv90 of equal to or less than about 50 microns, assessed using an optical microscope. Specifically, the paddle (100) has an immersible portion (142) defining a plurality of perforations (105); wherein the immersible portion (142) of the paddle (100) has an immersible area and the plurality of perforations (105) has a total perforated area, each measured by flattening the paddle (100) onto a 2-dimensional surface; and wherein the total perforated area of the plurality of perforations (105) is from about 1 to about 50% of the immersible area of the immersible portion (142).

### CROSS-REFERENCE TO RELATED APPLICATIONS

This application claims the benefit of U.S. Provisional Application No. 63/764,108, filed on Feb. 27, 2025, the disclosure of which is expressly incorporated by reference herein.

### TECHNICAL FIELD

The present disclosure generally relates to a method of forming an emulsion using a particular paddle. More specifically, the method includes the steps of providing a resin, a crosslinker, water, the particular paddle, and mixing the resin, the crosslinker and the water with the paddle to form the emulsion.

### BACKGROUND

Two-component (2K) coating compositions are widely used in industrial, automotive, and protective coatings due to their various desirable mechanical properties, chemical resistance, and durability. These compositions typically include a reactive resin and a crosslinker, which can chemically crosslink with the resin upon mixing. Because the reaction can begin upon combining the resin and the crosslinker, achieving a homogeneous and well-dispersed mixture within a controlled timeframe can be helpful to achieve good coating performance.

The traditional method for preparing 2K coating compositions involves manually and/or mechanically mixing the resin and the crosslinker, e.g. using a stirrer, a static mixer, or a rotary agitator. These conventional techniques generally rely on batch mixing, requiring precise ratio control, vigorous agitation, and rapid application before the mixture begins curing. While static mixers and rotary agitators can facilitate blending, these devices may include additional time-consuming operation and installation steps. In addition, they also frequently introduce inefficiencies such as incomplete dispersion, localized concentration variations, excessive air entrapment, etc.

Existing mixing devices face several challenges when handling 2K coatings. First, achieving rapid and thorough mixing without inducing premature curing or viscosity inconsistencies remains difficult. Many conventional mixers fail to provide uniform shear forces, leading to localized over- or under-mixing, which can compromise the final coating performance. Additionally, the introduction of air bubbles during mixing can affect film uniformity and introduce defects such as pinholes or fisheyes on surfaces of products. Ensuring an appropriate balance of agitation without excessive shear stress can be helpful to maintaining intended rheology of coating formulations and avoiding premature curing. Accordingly, there is an opportunity for improvement.

### BRIEF SUMMARY

The disclosure provides a method of forming an emulsion. The method includes the steps of providing a resin having a cross-linkable group, providing a crosslinker; providing water, providing a particular paddle; and mixing the resin, the crosslinker, and the water with the paddle to form the emulsion; wherein the emulsion includes a plurality of hydrophobic droplets having a particle size distribution Dv90 of equal to or less than about 50 microns, assessed using an optical microscope. The paddle has an immersible portion defining a plurality of perforations. The immersible portion has an immersible area. The plurality of perforations has a total perforated area, each measured by flattening the paddle to a 2-dimensional surface; and the total perforated area of the plurality of perforations is from about 1 to about 50% of the immersible area the immersible portion.

This disclosure also provides an additional method of forming an emulsion that includes water, a resin chosen from a hydroxyl-functional (meth)acrylic, a latex copolymer, and combinations thereof; and a crosslinker chosen from an isocyanate crosslinker, a melamine crosslinker, an amine crosslinker, and combinations thereof. This method utilizes the paddle that has the total perforated area that is from about 1 to about 20% of the immersible area the immersible portion.

This disclosure further provides a method of forming an emulsion wherein the resin includes a hydroxyl-functional (meth)acrylate copolymer; the crosslinker includes a polyisocyanate compound having a pendant —NCO group; and the total perforated area of the plurality of perforations is from about 1 to about 20% of the immersible area the immersible portion.

### BRIEF DESCRIPTION OF THE DRAWINGS

The present disclosure will hereinafter be described in conjunction with the following drawing figures, wherein like numerals denote like elements, and

FIG. 1. is a side perspective view of a paddle having a handle portion and an immersible portion defining a plurality of perforations;

FIG. 2 is a side perspective view of an embodiment wherein the paddle in FIG. 1 is immersed in an emulsion during a step of mixing;

FIG. 3 is a collection of drawings of the paddles used in Example III, Perforated Mixers 4-6 (A, B, and C) and Non-perforated Mixer 7 (D) from left to right, respectively;

FIG. 4 is a photograph of the paddles used in Example I, Perforated Mixers 1 and 2 (A and B) from left to right, respectively; and

FIG. 5A is an optical microscope image of an emulsion formed using Perforated Mixer 4, as described in Example III.

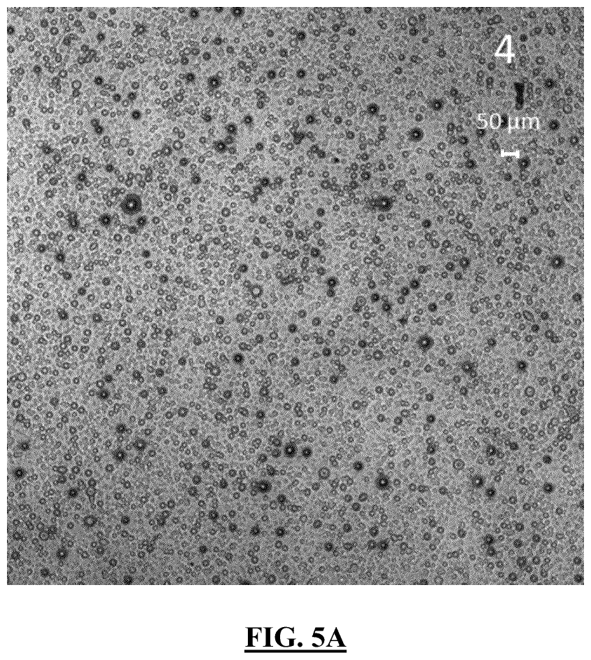

FIG. 5B is an optical microscope image of an emulsion formed using Perforated Mixer 5, as described in Example III.

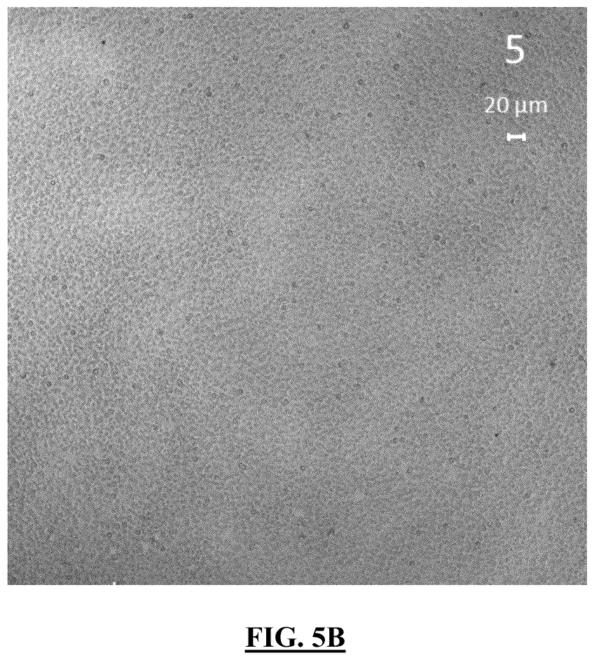

FIG. 5C is an optical microscope image of an emulsion formed using Perforated Mixer 6, as described in Example III.

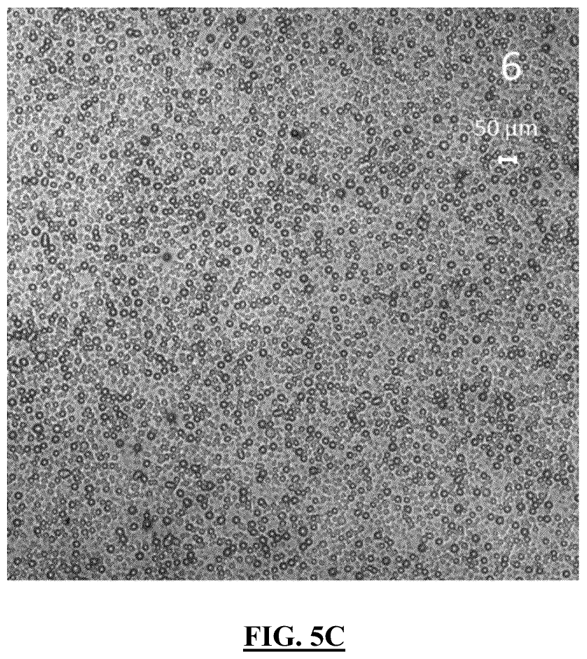

FIG. 5D is an optical microscope image of an emulsion formed using Non-perforated Mixer 7, as described in Example III.

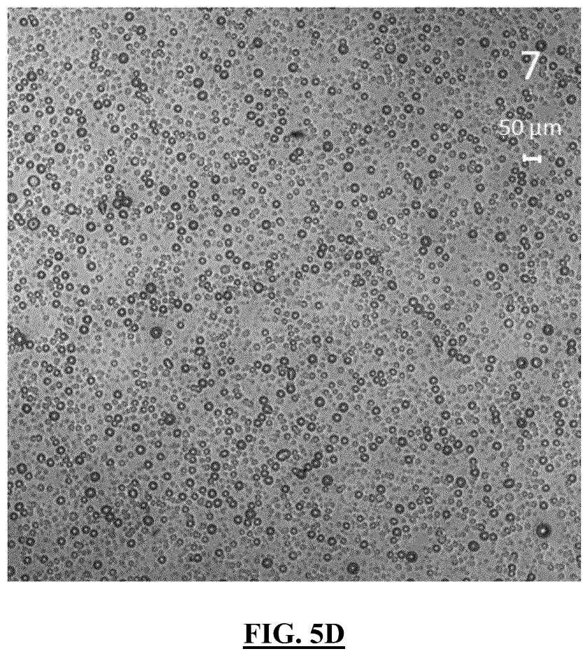

FIG. 6 is a collection of drawings (A, B, and C) of embodiments of perforations having varying shapes and edges.

### DETAILED DESCRIPTION

The disclosure provides a method of forming an emulsion. The method includes the steps of providing a resin having a cross-linkable group, providing a crosslinker, providing water, providing a particular paddle, and mixing the resin, the crosslinker and the water with the paddle to form the emulsion.

The following detailed description is merely exemplary in nature and is not intended to limit the current emulsion. Furthermore, there is no intention to be bound by any theory presented in the preceding background or the following detailed description.

Embodiments of the present disclosure are generally directed to emulsions and methods for forming the same. For the sake of brevity, conventional techniques related to forming components included in the emulsions, e.g. polymers, additives, etc. may not be described in detail herein. Moreover, the various tasks and process steps described herein may be incorporated into a more comprehensive procedure or process having additional steps or functionality not described in detail herein. In particular, various steps in the manufacture of polymers, additives, etc. and associated emulsions are well-known and so, in the interest of brevity, many conventional steps will only be described briefly herein or will be omitted entirely without providing the well-known process details.

In this disclosure, the terminology “about” can describe values 0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values described herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The emulsions disclosed herein may suitably comprise, consist of, or consist essentially of the components, elements, and process delineations described herein. The embodiments illustratively disclosed herein suitably may be practiced in the absence of any element which is not specifically disclosed herein.

The method of forming an emulsion may further be described as a method of mixing, emulsifying, combining, homogenizing, etc. one or more parts of the emulsion. The emulsion may further be described as a coating composition, e.g. a 1K composition, a 2K composition, waterborne coating composition, a clear coat, a base coat, etc. In various embodiments, the emulsion is described as a 2K coating composition and the method is described as a method of forming a 2K coating composition.

As first described above, the method includes the steps of providing the resin, providing the crosslinker, providing the water; providing the paddle, and mixing the resin, the crosslinker, and the water with the paddle to form the emulsion. These steps may be performed in any order, e.g. sequentially, concurrently, etc. One or more components of the emulsion, e.g. the resin, the crosslinker, the water, and any additional component, may be provided in a continuous or in a batch manner, in part or in whole amount, as determined by the skilled person. Various tools, equipment, systems, and techniques may be employed to achieve the steps described herein.

In various embodiments, the method includes the aforementioned steps, and the method may further include, or be free of, an additional step, e.g. providing an additive, monitoring and measuring the emulsion, heating the emulsion, diluting the emulsion, etc.

In other embodiments, the method comprises the aforementioned steps, and the method may further include, or be free of, an additional step, e.g. providing an additive, monitoring and measuring the emulsion, heating the emulsion, diluting the emulsion, etc.

In still other embodiments, the method consists of the aforementioned steps, and the method is free of an additional step, e.g. providing an additive, monitoring and measuring the emulsion, heating the emulsion, diluting the emulsion, etc.

In various embodiments, the method consists essentially of the aforementioned steps, and the method may optionally include an additional step, e.g., providing an additive, monitoring and measuring the emulsion, heating the emulsion, diluting the emulsion, etc., such that the emulsion formed therefrom exhibits the properties as described herein.

### Providing the Resin:

The step of providing the resin is not particularly limited and may be any known in the art. The resin may be alternatively described as a polymer, a binder, a binder component, a base component, a resin dispersion, a latex, etc. The resin itself may be procured from an in-house source, an external source, or a combination of sources. The step of providing may further be described as or further includes the step of preparing the resin, e.g. to use in the emulsion. Such preparation steps may be described as forming the resin, e.g. using various synthetic techniques known in the art, diluting, mixing, filtering, heating, inspecting, etc., or otherwise conditioning the resin to achieve desired physical properties for various applications.

The resin has a cross-linkable group. The terminology “cross-linkable group” can be used to describe a functional group that can crosslink with another cross-linkable group, e.g. during curing processes, to produce a crosslinked structure. The cross-linkable group can be positioned at any location of the chemical structure of the resin. Generally, the cross-linkable group can be present in a backbone position, in a pendant position from a backbone, terminally positioned on a backbone, or combinations thereof.

Typical cross-linkable groups can include hydroxyl, thiol, isocyanate, thioisocyanate, ketone, unsaturated hydrocarbons, acetoacetoxy, carboxyl, primary amine, secondary amine, epoxy, anhydride, ketimine, aldimine, groups or combinations thereof. Some other functional groups such as orthoester, orthocarbonate, or cyclic amide, groups, that can generate hydroxyl or amine groups once the ring structure is opened can also be suitable as cross-linkable groups.

The resin itself may be described in terms of the cross-linkable group. For example, the resin can have a hydroxyl cross-linkable group and can be described as a hydroxyl-functional resin. The resin may also be described as a homopolymer, a copolymer, etc. The resin may be any known in the art. In various embodiments, the resin is chosen from a hydroxyl-functional (meth)acrylic, a latex copolymer, and combinations thereof.

In various embodiments, the resin is or includes the hydroxyl-functional (meth)acrylate. Typically, the hydroxyl-functional (meth)acrylate may be described as a solvent-borne polymer that is subsequently inverted into an aqueous dispersion. The hydroxyl-functional (meth)acrylate may include a residue derived from a monomer including but not limited to (meth)acrylamide, N-substituted (meth)acrylamide, octyl(meth)acrylate, nonylphenol ethoxylate(meth)acrylate, isononyl(meth)acrylate, 1,6-hexanediol(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, octodecyl(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like.

In some embodiments, the hydroxyl-functional (meth)acrylate is the reaction product of a monomer mixture including at least one hydroxyl functional adduct of a monoepoxyester and an unsaturated carboxylic acid, at least one hydroxyl functional unsaturated monomer, at least one unsaturated acid functional monomer, optionally a vinyl aromatic monomer, optionally a polymerizable unsaturated monomer, and meth)acrylate monomer represented by Formula MA:

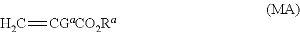

wherein G^{a} is hydrogen, halogen or methyl; and, R^{a} is: C1-C18 alkyl; C2-C18 heteroalkyl; C3-C18 cycloalkyl; C2-C8 heterocycloalkyl; C2-C8 alkenyl; or, C2-C8 alkynyl.

In other embodiments, the hydroxyl-functional (meth)acrylate may be prepared from a monomer mixture by a skew feed polymerization process with a monomer feed stream. The feed stream may include the hydroxyl functional adduct of a monoepoxyester and an unsaturated carboxylic acid; a hydroxyl functional unsaturated monomer, an unsaturated acid functional monomer, a (meth)acrylate monomer, a vinyl aromatic monomer, a polymerizable unsaturated monomer, or combinations thereof.

The monomer mixture may be co-polymerized alone or in combination with lauryl ethoxylate (meth)acrylate; cetyl ethoxylate (meth)acrylate; stearyl ethoxylate (meth)acrylate; behenyl ethoxylate (meth)acrylate; lauryl ethoxylate itaconate; cetyl ethoxylate itaconate; stearyl ethoxylate itaconate; behenyl ethoxylate itaconate; lauryl ethoxylate maleate; cetyl ethoxylate maleate; stearyl ethoxylate maleate; behenyl ethoxylate maleate, etc., or combinations thereof.

In various embodiments, the hydroxyl-functional (meth)acrylate is sourced commercially. Exemplary commercial hydroxyl-functional (meth)acrylate include products under the trademark Bahydrol®, available from Covestro; and, products under the trademark Setaqua®, available from Allnex.

In various embodiments, the resin is or includes the latex copolymer. The latex copolymer may be any in the art. For example, the latex copolymer may be described as a single-phase latex, a core-shell latex, an interpenetrating polymer network (IPN) latex, a hybrid latex, etc. The latex copolymer may be formed via an emulsion polymerization process and may typically include two or more types of acrylic/acrylate residues, such as those derived from the monomers first described above.

In various embodiments, the latex copolymer is described as a core-shell latex and the core-shell latex includes a polymeric core, urethane linkages, and carboxylic acid and hydroxyl functional groups. In other embodiments, the core-shell latex include a polymeric core at least partially encapsulated by a polymeric shell including the urethane linkages and carboxylic acid and hydroxyl functional groups, wherein the polymeric shell is covalently bonded to at least a portion of the polymeric core. In still other embodiments, at least a portion of the polymeric core of the core-shell particles includes an addition polymer formed from (meth)acrylic monomers, vinyl monomers, or combinations thereof. In additional embodiments, the core-shell latex includes urea linkages and urethane linkages and with keto functionality on the acrylic core and carboxylic acid functionality on the polyurethane shell.

In some embodiments, the resin may further be or include one or more of (meth)acrylated urethanes (i.e., urethane(meth)acrylates), (meth)acrylated epoxies (i.e., epoxy (meth)acrylates), (meth)acrylated polyesters (i.e., polyester(meth)acrylates), (meth)acrylated(meth)acrylics, (meth)acrylated silicones, (meth)acrylated amines, (meth)acrylated amides; (meth)acrylated polysulfones; (meth)acrylated polyesters, (meth)acrylated polyethers (i.e., polyether (meth)acrylates), vinyl(meth)acrylates, and (meth)acrylated oils.

Additionally, the resin can further be or include a polyether polyol resin, a polyester polyol resin, a polyester-polyurethane polymer, a melamine resin, or combinations thereof. Other non-limiting examples of the resin includes polyether polyol resins such as polypropylene glycol (PPG), polytetramethylene ether glycol (PTMEG), bisphenol A-based polyether polyols, etc.; polyester polyol resins such as neopentyl glycol (NPG) adipate, hexanediol adipate, isophthalic acid-based polyester polyols, terephthalic acid-based polyester polyols, caprolactone-based polyester polyols; acrylic polyol resins such as 2-ethylhexane-1,3-diol, butyl acrylate/hydroxyethyl acrylate copolymers, styrene-acrylic polyols, butyl methacrylate/hydroxyethyl methacrylate (HEMA) copolymers, 2-hydroxypropyl acrylate (HPA)-based acrylic resins, hydroxyl-functional acrylic resins such as hydroxyl-terminated poly(methyl methacrylate-co-butyl acrylate), hydroxylated styrene-acrylate resins, hydroxyl-functional ethyl acrylate copolymers, hydroxypropyl methacrylate (HPMA)-based acrylic resins, hydroxyl-functional (meth)acrylate copolymer; methacrylate resins such as poly(methyl methacrylate) (PMMA), Hydroxyethyl methacrylate (HEMA) copolymers, Butyl methacrylate/methyl methacrylate copolymers, methacrylate-styrene copolymers, etc.

In some embodiments, the resin may be or include a polyurethane. It is contemplated that zero, one, two, three, four, five, or even more individual polyurethanes may be used in the resin dispersion. The polyurethane is not particularly limited and may be any known in the art. In various embodiments, the polyurethane is the reaction product of a polyol and an isocyanate. Other polyurethanes can be made by first forming an NCO-functional hydrophilic polyurethane prepolymer by addition reaction of polyol type compounds and polyisocyanates, conversion of the so-formed polyurethane prepolymer into the aqueous phase, and then reacting the aqueously dispersed NCO-functional polyurethane prepolymer with an NCO-reactive chain extender like, for example, a polyamine, a hydrazine derivative or water.

As understood by the skilled person, the polyurethane may be described in terms of the reaction product of a compound having one or more hydroxyl groups (e.g. a monol, diol, triol, tetrol, or polyol) and an isocyanate. As such, regarding exemplary polyurethanes, those of skill in the art will understand the scope thereof based on examples of such reactive components, e.g. the polyol and the isocyanate, which are used to prepare many suitable polyurethanes for the polyurethane dispersion resin.

Hydroxyl-functional resins may also be used as the polyol to prepare the polyurethane, as the isocyanate may also be reacted with such a hydroxyl-functional resin. Such resins are not particularly limited and may be any known in the art, such as aliphatic or aromatic dicarboxylic acids, polyols, diols, aromatic or aliphatic cyclic anhydrides and cyclic alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further examples of suitable polycarboxylic acids can include aromatic and aliphatic polycarboxylic acids, such as phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols (e.g. polyhydric alcohols) can also be used.

The isocyanate is not particularly limited and may be any suitable for use in preparing the polyurethane resin. The isocyanate may be a mono or polyisocyanate, an aromatic isocyanate, an aliphatic isocyanate, and/or combinations thereof. In some embodiments, the isocyanate is or includes an aromatic isocyanate such as polymeric MDI. If the isocyanate is or includes an aromatic isocyanate, the aromatic isocyanate typically corresponds to the formula R′ (NCO)_{z} wherein R′ is a polyvalent aromatic organic radical, and z is an integer that corresponds to the valence of R′. Typically, z is at least two.

Other examples of suitable isocyanates include 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof.

Modified multivalent aromatic isocyanates may also be used, such as products obtained through chemical reactions of aromatic diisocyanates and/or aromatic polyisocyanates. Examples include polyisocyanates, ureas, biurets, allophanates, carbodiimides, uretonimines, and isocyanurate and/or urethane groups including diisocyanates and/or polyisocyanates such as modified diphenylmethane diisocyanates. The urethane groups of the isocyanate may be formed through reaction of a base isocyanate, as described above, with low molecular weight polyols, etc. as described herein. Likewise, the isocyanate may also include one or more prepolymers including isocyanate groups.

Additional isocyanate examples include modified benzene and toluene diisocyanates, e.g. employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. In various embodiments, the isocyanate may be an isocyanate chosen from 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof. The isocyanate may also include stoichiometric or non-stoichiometric reaction products of the aforementioned isocyanates.

In still other embodiments, examples of suitable polyisocyanates include aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate. Other polyisocyanates disclosed herein can also be suitable for producing polyurethanes.

Alternatively, the isocyanate may be a liquid polyisocyanate including one or more carbodiimide groups. In various embodiments, crude polyisocyanates may also be used, such as crude toluene diisocyanate obtained by the phosgenation of a mixture of toluenediamines or crude diphenylmethane isocyanate obtained by the phosgenation of crude isocyanates.

The isocyanates are not particularly limited in NCO content, and typically have an NCO content of from 5 to 35 wt %, based on a total weight of the resin. In various embodiments, the NCO content is from about 5 to about 35, about 10 to about 30, about 15 to about 25, or about 10 to about 20, wt %, based on a total weight of the resin. Determination of the NCO content on percent by weight can be accomplished by a standard chemical titration analysis known to those skilled in the art. In various non-limiting embodiments, all values and ranges of values, both whole and fractional, including and between the aforementioned values, are hereby expressly contemplated for use herein.

In some embodiments, the polyurethane may be a polyester-polyurethane polymer. In other words, the resin may be a resin dispersion including at least a polyester-polyurethane resin.

The polyester of the polyester-polyurethane polymer may be linear or branched. Useful polyesters can include esterification products of aliphatic or aromatic dicarboxylic acids, polyols, diols, aromatic or aliphatic cyclic anhydrides and cyclic alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further examples of suitable polycarboxylic acids include aromatic and aliphatic polycarboxylic acids, such as phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable.

Examples of suitable polyesters include branched copolyester polymers. The branched copolyester polymer and process for production described in U.S. Pat. No. 6,861,495, which is hereby incorporated by reference in various non-limiting embodiments, can be suitable. Polyesters prepared from monomers with multifunctional groups such as AₓB_{y} (wherein each of x and y is independently 1 to 3) types including those having one carboxyl group and two hydroxyl groups, two carboxyl groups and one hydroxyl group, one carboxyl group and three hydroxyl groups, or three carboxyl groups and one hydroxyl group can be used to create branched structures. Examples of such monomers include 2,3 dihydroxy propionic acid, 2,3 dihydroxy 2-methyl propionic acid, 2,2 dihydroxy propionic acid, 2,2-bis(hydroxymethyl) propionic acid, and the like.

The branched copolyester polymer can be conventionally polymerized from a monomer mixture containing a chain extender chosen from a hydroxy carboxylic acid, a lactone of a hydroxy carboxylic acid, and a combination thereof, and one or more branching monomers. Some of the suitable hydroxy carboxylic acids include glycolic acid, lactic acid, 3-hydroxypropionic acid, 3-hydroxybutyric acid, 3-hydroxyvaleric acid, and hydroxypivalic acid. Some of the suitable lactones include caprolactone, valerolactone; and lactones of the corresponding hydroxy carboxylic acids, such as, e.g., 3-hydroxypropionic acid, 3-hydroxybutyric acid, 3-hydroxyvaleric acid, and hydroxypivalic acid. In certain embodiments, caprolactone can is utilized. In embodiments, the branched copolyester polymer can be produced by polymerizing, in one step, the monomer mixture that includes the chain extender and hyper branching monomers, or by first polymerizing the hyper branching monomers followed by polymerizing the chain extenders. It is to be appreciated that the branched copolyester polymer can be formed from acrylic core with extending monomers described above.

The polyester-polyurethane polymer can be produced from the polyester and polyisocyanates. The polyester can be polymeric or oligomeric organic species with at least two hydroxyl-functionalities or two-mercapto functionalities and their mixtures thereof. Polyesters and polycarbonates with terminal hydroxy groups can be effectively used as the diols.

In some embodiments, the resin includes a polyester-polyurethane polymer formed from a linear polyester diol resin (reaction product of monomers 1,6-hexanediol, adipic acid, and isophthalic acid) and isophorone diisocyanate. This polyester-polyurethane polymer can have a weight average molecular weight of about 30,000, a solids content of about 35 wt %, and a particle size (e.g. Dv50) of about 250 nanometers, as determined using any apparatus known in the art, e.g. a Malvern Mastersizer.

In some embodiments, the resin includes a polyester-polyurethane polymer formed from a linear polycarbonate-polyester and isophorone diisocyanate. This polyester-polyurethane polymer can have a weight average molecular weight of about 75,000, a solids content of about 35 wt %, and a particle size (e.g. Dv50) of about 180 nanometers, as determined using any apparatus known in the art, e.g. a Malvern Mastersizer.

In some embodiments, the resin includes a polyester-polyurethane polymer formed from a slightly branched polyester polyol and hexamethylene diisocyanate, e.g. being about 40 wt % solid.

In some embodiments, the resin includes a polyester-polyurethane polymer formed from a linear polyester diol resin (e.g. that is the reaction product of monomers 1,6-hexanediol, adipic acid, and isophthalic acid) and isophorone diisocyanate, e.g. being about 35 wt % solid.

In another embodiment, the polyurethane is chosen from one formed from a branched polyester polyol and hexamethylene diisocyanate; formed from a linear polyester diol resin and isophorone diisocyanate wherein the linear polyester diol is the reaction product of 1,6-hexanediol, adipic acid, and isophthalic acid; formed from a linear polycarbonate-polyester polyol and isophorone diisocyanate; a polyester-polyurethane polymer; and combinations thereof.

In another embodiment, the resin may be, include, consist essentially of, or consist of, a polyurethane dispersion resin formed from a linear polycarbonate-polyester polyol and isophorone diisocyanate.

In some embodiments, the resin includes a polyester-polyurethane polymer having the tradename Bayhydrol® U 241 which is commercially available from Covestro AG of Leverkusen, Germany. The emulsion may include this polyester-polyurethane polymer in an amount of from about 0.1 to about 50, alternatively from about 1 to about 20, or alternatively from about 1 to about 10 wt. %, based on a total weight of the emulsion.

In some embodiments, the resin includes, consists essentially of, or consists of, the polyurethane. In such embodiments, the polyurethane is present in an amount of from about 1 to about 100, about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55 wt. % actives based on a total weight of the resin. In various non-limiting embodiments, all values and ranges of values, both whole and fractional, including and between the aforementioned values, are hereby expressly contemplated for use herein.

In some embodiments, the polyurethane is present in an amount of from about 1 to about 65, about 1 to about 60, about 1 to about 55, about 1 to about 45, about 1 to about 40, about 1 to about 25, about 1 to about 20, about 1 to about 15, about 1 to about 10, about 1 to about 5, about 5 to about 50, about 10 to about 45, about 15 to about 40, about 20 to about 35, about 25 to about 30, about 15 to about 20, about 15 to about 25, about 15 to about 30, about 10 to about 20, about 10 to about 25, about 10 to about 30, about 10 to about 35, about 18 to about 22, about 18 to about 20, about 16 to about 20, about 16 to about 22, about 16 to about 24 wt. %, weight percent actives based on a total weight of the resin. In various embodiments, this amount is from about 1 to about 15, e.g. of about 1, 2, 3, 4, 5, 6, 7, 8, 9, 10, 11, 12, 13, 14, or 15 wt. % actives, based on a total weight of the resin. In various non-limiting embodiments, all values and ranges of values, both whole and fractional, including and between the aforementioned values, are hereby expressly contemplated for use herein.

In other embodiments, the polyurethane is present in an amount of from about 1 to about 20, about 2 to about 19, about 3 to about 18, about 4 to about 17, about 5 to about 16, about 6 to about 15, about 7 to about 14, about 8 to about 13, about 9 to about 12, about 10 to about 11, or about 1, 2, 3, 4, 5, 6, 7, 8, 9, 10, 11, 12, 13, 14, 15, 16, 17, 18, 19, or 20 wt. % actives, based on a total weight of the emulsion. It is to be appreciated that amounts outside the ranges above may also be utilized. In various non-limiting embodiments, all values and ranges of values, both whole and fractional, including and between the aforementioned values, are hereby expressly contemplated for use herein.

In some embodiments, the resin, includes one or more of (meth)acrylated urethanes (i.e., urethane(meth)acrylates), (meth)acrylated epoxies (i.e., epoxy (meth)acrylates), (meth)acrylated polyesters (i.e., polyester(meth)acrylates), (meth)acrylated(meth)acrylics, (meth)acrylated silicones, (meth)acrylated amines, (meth)acrylated amides; (meth)acrylated polysulfones; (meth)acrylated polyesters, (meth)acrylated polyethers (i.e., polyether (meth)acrylates), vinyl(meth)acrylates, (meth)acrylated oils, and the like, or a combination thereof.

The resin may also include an amine, which may be any type known in the art, that may or may not react with an isocyanate to form a polyurea. The amine may include primary and secondary aliphatic and/or cyclic aliphatic amines. The amine may include any additional functional group known in the art including, hydroxyl groups, thiol groups, alkyl groups, cyclic groups, aromatic groups, and combinations thereof. It is to be understood that the amine may also include an amide, which also may be any type known in the art. The amide may include or otherwise be present as a polyester amide obtained from polymers of unsaturated or saturated carboxylic acids or anhydrides, and multifunctional unsaturated or saturated amino-alcohols, as well as combinations thereof.

The resin may have any weight average molecular weight. Generally, a weight average molecular weight of from about 100 Da to about 100,000 Da can be used. The weight average molecular weight of the resin may be measured using any method known in the art. For example, the weight average molecular weight may be measured according to a standardized method, e.g. ASTM D6474, ASTM D4001-13, ASTM D3593, etc., each as published in 2025. Alternatively, the weight average molecular weight may be measured using a technique known in the art, including but not limited to a gel permeation chromatography technique, e.g. coupled with any detector known in the art, e.g. MALS, RI, etc., a mass spectrometry technique, etc. In various embodiments, the weight average molecular of the resin, measured using any of the aforementioned method, is from about 100 to about 100,000 Da, about 1000 to about 90,000, about 2000 to about 80,000, about 3000 to about 70,000, about 4000 to about 60,000, about 5000 to about 50,000, about 6000 to about 40,000, about 7000 to about 30,000, about 8000 to about 20,000, or about 9000 to about 10,000 Da. In various other embodiments, the resin has a weight average molecular weight of from about 100 to about 10,000 Da, about 500 to about 9500, about 1000 to about 9000, about 1500 to about 8500, about 2000 to about 8000, about 2500 to about 7500, about 3000 to about 7000, about 3500 to about 6500, about 4000 to about 6000, about or 4500 to about 5500, Da. In various non-limiting embodiments, all values and ranges of values, both whole and fractional, including and between the aforementioned values, are hereby expressly contemplated for use herein.

The resin may exhibit various physical properties, as selected or conditioned as appropriate for various coating applications. For example, the resin may have various solids content. In various embodiments, the resin has a solids content of from about 30 to about 100 wt %, about 40 to about 90, about 50 to about 80, or about 60 to about 70, wt %. In yet other embodiments, the solids content of the resins is from about 30 to about 50, about 31 to about 49, about 32 to about 48, about 33 to about 47, about 34 to about 46, about 35 to about 45, about 36 to about 44, about 37 to about 43, about 38 to about 42, about 39 to about 41, or about 39 to about 40, wt %. In various non-limiting embodiments, all values and ranges of values, both whole and fractional, including and between the aforementioned values, are hereby expressly contemplated for use herein.

The resin may be provided in various amounts, e.g. depending on the type of resin and properties desired for different coating applications. Typically, the resin can be provided in an amount such that when present in the emulsion, the resin is present in an amount of from about 20 to about 90 wt % actives. In various embodiments, the amount of the resin present in the emulsion is from about 20 to about 90, about 25 to about 90, about 30 to about 90, about 35 to about 85, about 40 to about 80, about 45 to about 75, about 50 to about 70, about 55 to about 65, or about 55 to about 60, wt % actives. In other embodiments, the amount of the resin present in the emulsion is from about 20 to about 30, about 21 to about 29, about 22 to about 28, about 23 to about 27, about 24 to about 26, and about 24 to about 25, wt % actives. In various embodiments, all values and ranges of values, both whole and fractional, including and between the aforementioned values, are hereby expressly contemplated for use herein.

The resin may be provided in a physical state that is solid, liquid, a dispersion, etc. In various embodiment, the resin is provided as a dispersion in a carrier such as water, water soluble solvents, e.g. methanol, propanol, butanol, ethanol, acetaldehyde, acetic acid, acetone, acetonitrile, ethylene glycol, etc.

When the resin is a dispersion or a liquid, the resin may also exhibit various viscosities, typically from about 100 to about 50,000 mPas. The viscosity of the resin may be measured using any method known in the art, e.g. using Brookfield viscometer, a capillary viscometer, etc., at a temperature of from about 10 to about 50° C., alternatively from about 20 to about 40, about 20 to about 30, ° C., and at any shear rate, e.g. typically from about 0.1 to about 1000 s⁻¹, alternatively from about 0.1 to about 500, about 1 to about 100, or about 1 to about 10, s⁻¹, etc. The viscosity of the resin may also be measured using a standardized method, e.g. ASTM-D2196, ASTM-D1725-04, ISO 2555:2018, ISO3219, etc., each as published in 2025. In various embodiments, the viscosity of the resin, as measured using any of the aforementioned methods, is from about 100 to about 50,000 mPas, about 500 to about 50,000, about 1000 to about 45,000, about 2000 to about 40,000, about 3000 to about 35,000, about 4000 to about 30,000, about 5000 to about 20,000, or about 5000 to about 10,000, mPas. In other embodiments, the resin exhibits a viscosity of from about 100 to about 2000, about 200 to about 2000, about 300 to about 2000, about 400 to about 2000, about 500 to about 2000, about 600 to about 1900, about 700 to about 1800, about 800 to about 1700, about 900 to about 1600, about 1000 to about 1500, mPas. In various embodiments, all values and ranges of values, both whole and fractional, including and between the aforementioned values, are hereby expressly contemplated for use herein.

Various other physical and chemical properties of the resin such as a hydroxyl equivalent weight, gel time, pot life, cure speed, cure temperature may be observed/measured. Typically, these properties can provide insights to the reactivity and crosslinking ability of the resin, and may depend on other factors and parameters, including parameters previously described above, i.e. molecular weight, solids content, etc., in addition to the type of crosslinker, parameters associated with the step of mixing, etc.

Generally, the resin can have a hydroxyl equivalent weight of from about 100 to about 1000 g/eq. The hydroxyl equivalent weight can be used to determine the amount of the crosslinker that can react with the resin. Furthermore, the hydroxyl equivalent may also affect the reaction time of the crosslinking process. The hydroxyl equivalent weight may be measured using any method known in the art. For example, a titration technique may be used, e.g. titrating with acetic anhydride, titrating with potassium hydroxide. Alternatively, the hydroxyl equivalent may be determined using gel permeation chromatography, which may be performed using any conditions as deem appropriate by the skilled person and may utilize any detector known in the art, e.g. UV, MALS, MS, etc. In various embodiments, the hydroxyl equivalent, measured using any one of the aforementioned methods, is from about 100 to about 1000, about 150 to about 950, about 200 to about 900, about 250 to about 850, about 300 to about 800, about 350 to about 750, about 400 to about 700, about 450 to about 650, or about 500 to about 600, g/eq. In various embodiments, all values and ranges of values, both whole and fractional, including and between the aforementioned values, are hereby expressly contemplated for use herein.

Conditions and workability of the resin, e.g. before curing starts, may be assessed using a gel time and/or pot life of the resin. Typically, a longer gel time and/or pot life can allow for more flexibility in working conditions of the resin but can reduce time efficiency. In contrast, a shorter gel time and/or pot life can allow for quick applications but may shorten working time. In various embodiments, the gel time of the resin is from about 10 minutes to about 5 hours, about 30 minutes to about 4 hours, about 1 hour to about 3 hours, or about 1 hour to about 2 hours. In other embodiments, the gel time of the resin is from about 10 minutes to about 1 hour, about 15 minutes to about 50 minutes, about 20 minutes to about 40 minutes, or about 15 minutes to about 30 minutes. In various embodiments, all values and ranges of values, both whole and fractional, including and between the aforementioned values, are hereby expressly contemplated for use herein.

In various embodiments, the pot life of the resin is from about 30 minutes to about 5 hours, about 30 minutes to about 4 hours, about 1 hour to about 3 hours, or about 1 hour to about 2 hours. In various embodiments, all values and ranges of values, both whole and fractional, including and between the aforementioned values, are hereby expressly contemplated for use herein.

### Providing the Crosslinker:

The method also includes the step of providing the crosslinker. The crosslinker may be further described as an activator, a curing agent, an activating agent, a hydrophobic component, a hydrophobic activator component, etc. The step of providing the crosslinker may be further described as obtaining the crosslinker from an external source, an internal source, or a combination of sources. The step of providing may also be or include the step of forming and/or preparing the crosslinker. In various embodiments, the step of forming is performed using various chemical reactions known in the art, which may depend on the type of the crosslinker. In other embodiments, the step of preparing is performed and may be further described as diluting, mixing, filtering, heating, inspecting, etc., or otherwise conditioning the resin to achieve desired physical properties e.g. to use in the emulsion.

The terminology “crosslinker” can be used to describe a compound having a cross-linkable group that is capable of crosslinking with, e.g. covalently bonding to, another cross-linkable group, e.g. on the resin, to produce a crosslinked structure, thereby increasing the molecular weight of the resin to achieve desirable properties for various applications. The cross-linkable group may be positioned in any location of the crosslinker. For example, the cross-linkable group is positioned in the backbone, pendant from the backbone, terminally positioned on the backbone, of the chemical structure of the crosslinker, or a combination thereof.

The crosslinker itself is not particularly limited and may be any known in the art. In various embodiments, the crosslinker is chosen from an isocyanate crosslinker, a melamine crosslinker, an amine crosslinker, and combinations thereof. In various embodiments, the crosslinker is or includes an isocyanate crosslinker. In other embodiments, the crosslinker is or includes a polyisocyanate compound having pendant —NCO groups.

The emulsion may include more than one type of crosslinker that has the same or different cross-linkable groups. Typical groups can include hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide, or combinations thereof.

In some embodiments, the emulsion includes a melamine crosslinker. Suitable melamine crosslinkers may be melamine resins that are partially or fully etherified with one or more alcohols like methanol or butanol (e.g. hexamethoxymethyl melamine). Examples of other suitable melamine crosslinkers include monomeric melamine, polymeric melamine-formaldehyde resins, and combinations thereof. Monomeric melamines include low molecular weight melamines, e.g. which contain, on an average, three or more methylol groups etherized with a C₁ to C₅ monohydric alcohol such as methanol, n-butanol, or isobutanol per triazine nucleus, and have an average degree of condensation up to about 2 and, in certain embodiments, of from about 1.1 to about 1.8, and have a proportion of mononuclear species not less than about 50 percent by weight. By contrast the polymeric melamines can have an average degree of condensation of more than about 1.9. Some such suitable monomeric melamines include alkylated melamines, such as methylated, butylated, isobutylated melamines and mixtures thereof.

Some suitable monomeric melamines are available commercially. For example, Cytec Industries Inc., West Patterson, N.J. supplies Cymel® 301 (degree of polymerization of 1.5, 95% methyl and 5% methylol), Cymel® 350 (degree of polymerization of 1.6, 84% methyl and 16% methylol), 303, 325, 327, 370 and XW3106, can be suitable monomeric melamines. Suitable polymeric melamines include high amino (partially alkylated, —N, —H) melamine known as Resimene® BMP5503 (weight average molecular weight 690, polydispersity of 1.98, 56% butyl, 44% amino), which is supplied by Solutia Inc., St. Louis, Mo., or Cymel® 1158 provided by Cytec Industries Inc., West Patterson, N.J. Cytec Industries Inc. also supplies Cymel® 1130 with 80 percent solids (degree of polymerization of 2.5), Cymel® 1133 (48% methyl, 4% methylol and 48% butyl), both of which are polymeric melamines.

In exemplary embodiments, the emulsion includes as the crosslinker, and a melamine-formaldehyde resin having the tradename Cymel® 303, which is commercially available from Cytec Industries Inc. of West Patterson, N.J.

Other crosslinkers may also be utilized in the emulsion. For example, an isocyanate-based crossline may be utilized. Alternatively, both an isocyanate crosslinker and a melamine crosslinker can be used.

Examples of isocyanate crosslinkers are not particularly limited and may be any known in the art. In various embodiments, this isocyanate crosslinker is or includes an aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate.

In various embodiments, isocyanates such as oligomers based on hexamethylene diisocyanate (HDI), diphenylmethane diisocyanate (MDI), isophorone diisocyanate (IPDI), or toluidine diisocyanate (TDI), e.g. isocyanurates, biuret, allophanates, and adducts of the isocyanates mentioned above with polyhydric alcohols and mixtures thereof can be used as a crosslinker These can react with polyols such as, for example, OH group-containing polyesters, polyethers, acrylates and polyurethane, and mixtures thereof, which polyols may be solvent-based, solvent-free, or water-dilutable. In various embodiments, monofunctional isocyanates are contemplated for use herein, as selected by one of skill in the art. In other embodiments, blocked isocyanates are contemplated for use herein, as selected by one of skill in the art.

Polyisocyanate-functional adducts having isocyanurate structural units can also be used in or as the crosslinker. For example, the adduct of 2 molecules of a diisocyanate, such as hexamethylene diisocyanate or isophorone diisocyanate, and a diol such as ethylene glycol; the adduct of 3 molecules of hexamethylene diisocyanate and 1 molecule of water (commercially available from Bayer Corporation of Pittsburgh, Pennsylvania under the trade name Desmodur® N); the adduct of 1 molecule of trimethylol propane and 3 molecules of toluene diisocyanate (commercially available from Bayer Corporation of Pittsburgh, Pennsylvania under the trade name Desmodur® L); the adduct of 1 molecule of trimethylol propane and 3 molecules of isophorone diisocyanate or compounds, such as 1,3,5-triisocyanato benzene and 2,4,6-triisocyanatotoluene; and the adduct of 1 molecule of pentaerythritol and 4 molecules of toluene diisocyanate.

In various embodiments, the polyisocyanate is or includes hydrophilic pre-polymers formed via ionically or non-ionically modification of an aliphatic, cycloaliphatic, aromatic and heterocyclic isocyanates, such as those first described above, with polyether polyols, polyester polyols and/or ionic functional groups to form isocyanate functional oligomers, which may be used alone or in combination with a free isocyanate.

In various embodiments, the crosslinker is utilized in an amount of from about 5 to about 50, about 10 to about 45, about 15 to about 40, about 20 to about 35, or about 20 to about 30, wt. %, based on the total weight actives in the emulsion. In other embodiments, this amount is from about 5 to about 20, about 6 to about 19, about 7 to about 18, about 8 to about 17, about 9 to about 16, about 10 to about 15, wt %, based on a total weight of the emulsion. In various embodiments, all values and ranges of values, both whole and fractional, including and between the aforementioned values, are hereby expressly contemplated for use herein.

### Providing the Water:

The method further includes the step of providing the water. The water may be provided as an individual component, e.g. in a separate step, or may be included in other components in the emulsion, e.g. the resin, the crosslinker, and/or any additional component.

The emulsion includes water, e.g. as a carrier, a solvent, a diluent, etc. The particular components of the emulsion and applications may affect the amount of water in the emulsion. The water may be present in an amount that balances the weight of the emulsion, e.g. to about 100 wt %. In various embodiments, the emulsion can include from about 30 to about 90 wt % of water, based on the total weight of the emulsion. In other embodiments, the emulsion includes from about 35 to about 85 wt %, about 40 to about 80 wt %, about 45 to about 75 wt %, about 50 to about 70 wt %, or about 55 to about 65 wt %, based on a total weight of the emulsion. In various embodiments, all values and ranges of values, both whole and fractional, including and between the aforementioned values, are hereby expressly contemplated for use herein.

### Providing an Additional Component:

The emulsion may include, or be free of, an additional component. Accordingly, the method of forming the emulsion may include, or be free of, the step of providing the additional component. Additional components may be included in the emulsion for various purposes, generally to help obtain particular physical and chemical properties for various coating applications. The additional component is not particularly limited and may be any known in the art. Non-limiting examples of additional components include a catalyst; a plasticizer; a stabilizer; a diluent; a desiccant; an adhesion promoter; a wetting agent; a defoamer; a flame retardant; a rheology control agent; a pigment; a solvent; etc., and combinations thereof.

The emulsion may also include, or be free of, a pigment. In some embodiments, the emulsion includes a pigment. Any pigment known in the art may be utilized in the emulsion. Non-limiting examples of suitable pigments include metallic oxides, metal hydroxide, effect pigments including metal flakes, chromates, such as lead chromate, sulfides, sulfates, carbonates, carbon black, silica, talc, china clay, phthalocyanine blues and greens, organo reds, organo maroons, pearlescent pigments, other organic pigments and dyes, and combinations thereof.

The emulsion may include about 1 to about 30 wt %, of a pigment based on a total weight of the emulsion. In various embodiments, the pigment is present in an amount of from about 1 to about 30, about 5 to about 25, about 10 to about 20, or about 15 to about 30, wt %, based on a total weight of the emulsion. In various embodiments, all values and ranges of values, both whole and fractional, including and between the aforementioned values, are hereby expressly contemplated for use herein.

The emulsion may also include, or be free of, a solvent, i.e., any organic or solvent compatible with the emulsion. Non-limiting examples of suitable solvents may include aromatic hydrocarbons; ketones, such as, acetone, methyl ethyl ketone, methyl isobutyl ketone, methyl amyl ketone and diisobutyl ketone; esters, such as, ethyl acetate, n-butyl acetate, isobutyl acetate, and a combination thereof.

In some embodiments, the solvent is chosen from water-soluble solvents. In various embodiments, the water-soluble solvent may be methanol, propanol, butanol, ethanol, 1,2-butanediol, 1,3-butanediol, 1,3-propanediol, 1,4-butanediol, 1,4-dioxane, 1,5-pentanediol, 2-butoxyethanol, 2-propanol, acetaldehyde, acetic acid, acetone, acetonitrile, butyric acid, diethanolamine, diethylenetriamine, dimethoxyethane, dimethyl sulfoxide, dimethylformamide, ethylamine, ethylene glycol, formic acid, furfuryl alcohol, glycerol, methyl diethanolamine, methyl isocyanide, n-methyl-2-pyrrolidone, propanoic acid, propylene glycol, pyridine, tetrahydrofuran, triethylene glycol, glycol ethers (ethylene glycol monobutyl ether, diethylene glycol monobutyl ether, propylene glycol methyl ether, etc., any and all isomers thereof, or combinations thereof.

In various embodiments, the solvent, including any one or more of the additional solvents selected for use, is present in an amount of from about 0.1 to about 25, about 1 to about 20, about 2 to about 19, about 3 to about 18, about 4 to about 17, about 5 to about 16, about 6 to about 15, about 7 to about 14, about 8 to about 13, about 9 to about 12, or about 10 to about 11, wt % actives based on a total weight of the emulsion. In various non-limiting embodiments, all values and ranges of values, both whole and fractional, including and between the aforementioned values, are hereby expressly contemplated for use herein.

The emulsion may further include, or be free of, a catalyst. The emulsion may further include a catalyst to reduce curing time and to allow curing of the emulsion at ambient, e.g. from about 18° C. to about 35° C. or elevated temperatures. Non-limiting examples of suitable catalysts may include organic metal salts, such as, dibutyl tin dilaurate, dibutyl tin diacetate, dibutyl tin dichloride, dibutyl tin dibromide, zinc naphthenate; triphenyl boron, tetraisopropyl titanate, triethanolamine titanate chelate, dibutyl tin dioxide, dibutyl tin dioctoate, tin octoate, aluminum titanate, aluminum chelates, zirconium chelate; tertiary amines; alkanolamine compounds; 2,3-dimethyl-3,4,5,6-tetrahydropyrimidine; tetraalkylammonium hydroxides, 1,8-diazabicycloundec-7-ene (DBU); 1,5-diazabicyclo[4.3.0]non-5-ene; 1,4-diazabicyclo[2.2.2]octane; 4-dimethylaminopyridine; 1,5,7-triazabicyclo[4.4.0]dec-5-ene; 7-methyl-1,5,7-triazabicyclo[4.4.0]dec-5-ene; 1,8-bis(tetramethylguanidino)naphthalene; and, 2-tert-butyl-1,1,3,3-tetramethylguanidine, hydrocarbon phosphonium halides, such as, ethyl triphenyl phosphonium iodide and other such phosphonium salts and other catalysts, or a combination thereof.

The emulsion may include the catalyst in an amount of from about 0.01 to about 5, about 0.01 to about 4, about 0.05 to about 3, about 0.1 to about 2, or about 0.5 to about 1, based on a total weight of the emulsion. In various non-limiting embodiments, all values and ranges of values, both whole and fractional, including and between the aforementioned values, are hereby expressly contemplated for use herein.

The emulsion may further include, or be free of, a stabilizer, e.g. an ultraviolet light stabilizer, a hindered light stabilizer. Non-limiting examples of stabilizers include ultraviolet light absorbers, screeners, quenchers, and hindered amine light stabilizers. An antioxidant can also be added to the emulsion. Typical ultraviolet light stabilizers can include benzophenones, triazoles, triazines, benzoates, hindered amines and mixtures thereof. A blend of hindered amine light stabilizers, such as Tinuvin®328 and Tinuvin®123, all commercially available from Ciba Specialty Chemicals of Tarrytown, New York, under the trade name Tinuvin®, can be utilized.

The emulsion may further include, or be free of, other additives known in the art such as wetting agents, leveling and flow control agents, for example, Resiflow® S (polybutylacrylate), BYK® 320 and 325 (high molecular weight polyacrylates), BYK® 347 (polyether-modified siloxane) under respective trade names, leveling agents based on (meth)acrylic homopolymers; rheological control agents; thickeners, such as partially crosslinked polycarboxylic acid or polyurethanes; and antifoaming agents. The other additives can be used in conventional amounts familiar to those skilled in the art.

Certain wetting agents, leveling agents, flow control agents, and surfactants may be incorporated into the emulsion, e.g. for increasing or decreasing surface tension of the emulsion for various applications. The emulsion may include the leveling agent in an amount of from about 0.1 to about 10, about 1 to about 10, about 2 to about 9, about 3 to about 8, about 4 to about 7, or about 5 to about 6, based on a total weight of the emulsion. In various non-limiting embodiments, all values and ranges of values, both whole and fractional, including and between the aforementioned values, are hereby expressly contemplated for use herein.

The emulsion may further include, or be free of, a rheology control agent. The rheology control agent may include a filler, a thickener or combinations thereof. Non-limiting examples of rheology control agents include fumed silica, bentonite clays, or organoclays, hydroxyethylcellulose (HEC), hydroxypropylcellulose (HPC), polyurethane dispersions (PUDs), acrylate dispersions, etc.

The amount of the rheology control agent in the emulsion can typically be from about 0 to about 10 wt %, based on the weight of the emulsion. The emulsion may include, for example, from 0 to 8 wt. %, from 0 to 5 wt. % or from 0 to 2 wt. % of rheology control agent, based on the weight of the emulsion. In various non-limiting embodiments, all values and ranges of values, both whole and fractional, including and between those set forth above are expressly contemplated for use herein.

### Providing the Paddle:

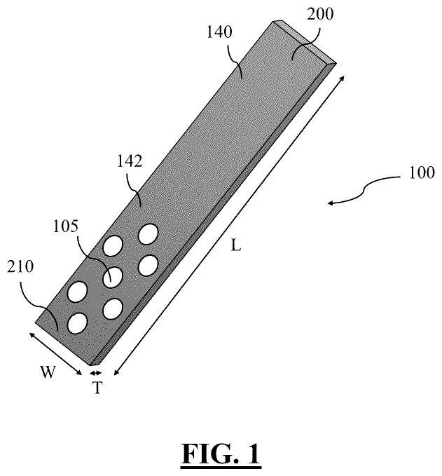

The method also includes the step of providing the paddle (100), e.g. as shown in FIG. 1. The paddle (100) may be described as a mixer, a mixing paddle, a mixing device, a mixing stick, a manual mixer, a perforated mixer, a perforated paddle, etc. The paddle (100) may be used for mixing, combining, homogenizing, emulsifying, etc. components of the emulsion, e.g. to form the emulsion. The paddle (100) may be made in-house or obtained from a commercial source. The paddle (100) may alternatively be obtained commercially and modified in-house.

The paddle (100) itself may include any material known in the art. For example, the paddle (100) may be or include a cellulosic material, e.g. wood, etc., a metal, e.g. iron, aluminum, etc., a plastic material, e.g. polyester, polyurethane, polyvinyl chloride, polyethylene, etc. The paddle (100) may be or include one or more types of materials, such as those previously described. In various embodiments, the paddle (100) is or includes wood. In other embodiments, the paddle (100) is or includes a metal. In yet other embodiments, the paddle (100) is or includes a plastic material.

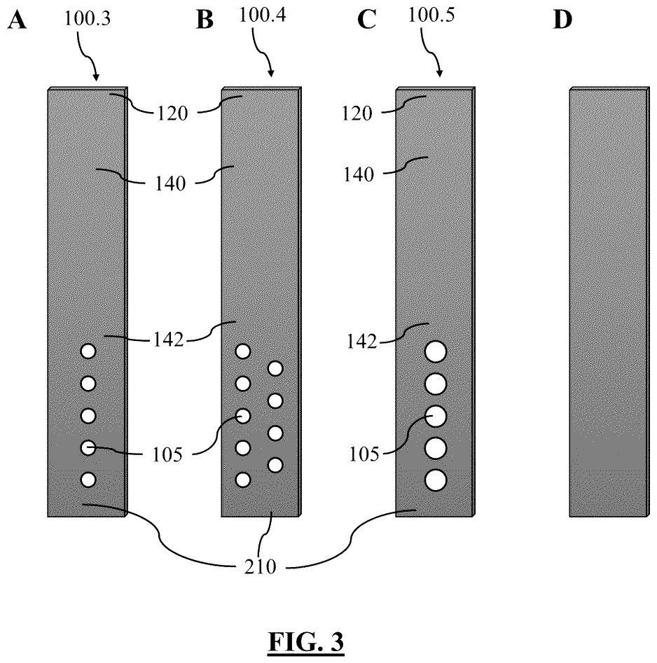

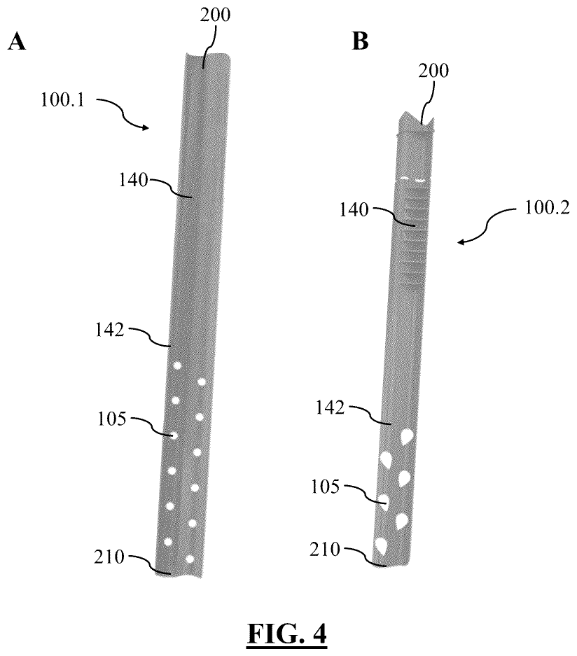

The paddle (100) may have any shape and/or dimensions known in the art. The paddle (100) may have one or more shapes. For example, the paddle (100) may have a uniform shape or include portions that have different shapes. In various embodiments, the entire paddle (100) or a portion of the paddle (100) has an approximately oblong or rectangular shape. In other embodiments, the entire paddle (100) or a portion of the paddle (100) has an approximately square-like shape. Various embodiments of the paddle (100) are shown in FIGS. 3 and 4, and each embodiments of the paddle (100) may be referred to as (100.1), (100.2), (100.3), (100.4), (100.5), etc.

FIG. 1 illustrates an embodiment of the paddle (100) that has a handle portion (140) and an immersible portion (142) defining a plurality of perforations (105). The paddle (100) may be further described using one or more of its dimensions. As illustrated in FIG. 1, the paddle (100) may have a width (W), a length (L) and a thickness (T) that may be measured, calculated, and/or estimated directly or indirectly. Specific methods of obtaining the dimensions may be chosen by the skilled person, as appropriate for each type of paddle. Furthermore, the paddle (100) may be or include a flat surface, such as those in FIG. 3, and/or a curved surface, e.g. concave, convex, such as those in FIG. 4, etc., which may further guide the process of obtaining the dimensions. For example, one or more dimensions of the paddle (100) may be measured directly with a ruler, a caliper, a profilometer, etc. Direct measurement can generally be used for paddles (100) or portions of the paddles (100) that are flat. Alternatively, one or more dimensions of the paddle (100) may be obtained indirectly, e.g. using a mathematical equation, using a computational model, projecting the paddle (100) on a flat surface, physical and/or theoretical flattening of the paddle (100), e.g. to enable dimension measurement and/or calculation, etc. Indirect measurement can generally be used for paddles (100) or portions of the paddles (100) that are curved. In various embodiments, one or more dimensions of the paddle (100) are determined by flattening the paddle (100) into a two-dimensional (2D) surface.

In various embodiments, the length (L) of the paddle (100), measured using any of the aforementioned methods, is from about 1 cm to about 10 m. In various embodiments, the length (L) of the paddle (100) is from about 1 m to about 10 m, about 2 m to about 9 m, about 3 m to about 8 m, about 4 m to about 7 m, or about 5 m to about 6 m. In yet other embodiments, the length (L) is from about 1 cm to about 1 m, about 10 cm to about 1 m, about 20 cm to about 90 cm, about 30 cm to about 80 cm, about 40 cm to about 70 cm, or about 50 cm to about 60 cm. In various embodiments, all values and ranges of values, both whole and fractional, including and between the aforementioned values, are hereby expressly contemplated for use herein.

In various embodiments, the width (W) of the paddle (100), measured using any of the aforementioned methods, is from about 1 cm to about 10 m. In various embodiments, the width (W) of the paddle (100) is from about 1 m to about 10 m, about 2 m to about 9 m, about 3 m to about 8 m, about 4 m to about 7 m, or about 5 m to about 6 m. In yet other embodiments, the width (W) is from about 1 cm to about 1 m, about 10 cm to about 1 m, about 20 cm to about 90 cm, about 30 cm to about 80 cm, about 40 cm to about 70 cm, or about 50 cm to about 60 cm. In various embodiments, all values and ranges of values, both whole and fractional, including and between the aforementioned values, are hereby expressly contemplated for use herein.

In various embodiments, the ratio of length (L) to width (W) of the paddle (100), measured using any of the aforementioned methods, is from about 1:1 to about 100:1. In various embodiments, the ratio is from about 1:1 to about 100:1, about 1:10 to about 90:1, about 1:20 to about 80:1, about 1:30 to about 70:1, about 1:40 to about 60:1, about 1:50 to about 75:1, etc. In various embodiments, all values and ranges of values, both whole and fractional, including and between the aforementioned values, are hereby expressly contemplated for use herein.

In various embodiments, the thickness (T) of the paddle (100), measured using any of the aforementioned methods, is from about 0.5 to about 100 mm. In various embodiments, the thickness (T) is from about 1 to about 100, 10 to about 90, about 20 to about 80, about 30 to about 70, about 40 to about 60, or about 40 to about 50, mm. In various embodiments, all values and ranges of values, both whole and fractional, including and between the aforementioned values, are hereby expressly contemplated for use herein.

The paddle (100) may or may not have one or more portions, one of which may be described as a handle portion (140), and another may be described as an immersible portion (142), typically along the length (L) of the paddle (100). Generally, the handle portion (140) can be used to hold the paddle (100), e.g. to mix the emulsion, to attach to a component, e.g. to facilitate mixing, etc. The paddle (100) has an immersible portion (142) defining a plurality of perforations (105). In various embodiments, the paddle (100) has the handle portion (140) which defines a first end (200) of the paddle (100) and the immersible portion (142) which defines a second end (210) of the paddle (100). The handle portion (140) and the immersible portion (142) may be or appear approximately the same as, or different from, each other.

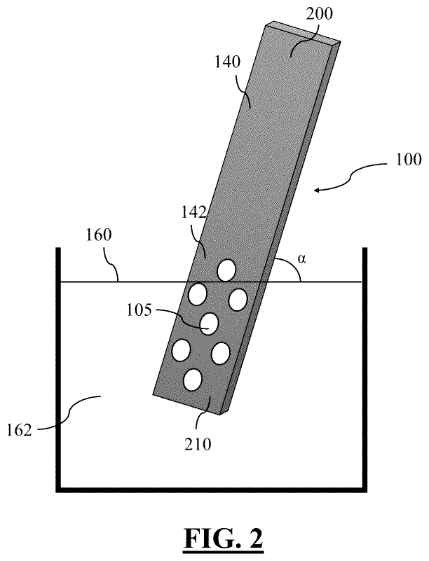

FIG. 2. illustrates a non-limiting embodiment where the paddle (100) is dipped, submerged, or immersed into the emulsion (162). More specifically in FIG. 2, a part of the paddle (100) is immersed into the emulsion (162). In other embodiments, the entire paddle (100) can be immersed into the emulsion (162) such that the handle portion (140) is also immersed in the emulsion (162) and may or may not utilized as a handle. To be clear, the handle portion (140) does not need to be utilized as a handle in the method. For example, the entire paddle (100) can be immersed into the emulsion (162) and the paddle (100) may be moved using a magnet, i.e. the paddle (100) can behave as a stir bar, to mix the emulsion (162). In another example, the entire paddle (100) can be immersed into the emulsion (162) and the paddle (100) and the emulsion (162) may be shaken, i.e. the paddle (100) can behave as an agitator, to mix the emulsion (162).

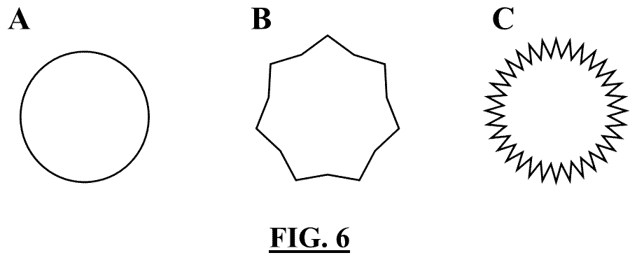

The plurality of perforations (105) may be alternatively described as holes, openings, cutouts, etc. The plurality of perforations (105) may be formed using any method known in the art. For example, the plurality of perforations (105) may be laser cut, punctured, formed from a mold, etc. Each of the plurality of perforations (105) may independently have any shape or size. For example, each of the plurality of perforations (105) may be approximately circular, e.g. as shown in FIG. 6A, elliptical, triangular, square, rectangular, leaf-shaped, star-shaped, irregularly shaped, etc., e.g. as shown in FIGS. 6B and 6C. Each of the plurality of perforations (105) can have the same shape or a different shape from another one of the plurality of perforations (105).

The size of each of the plurality of perforation (105) may be further described in terms of radius or diameter, e.g. each the plurality of perforations (105) can have an approximately circular shape, e.g. as shown in FIG. 6A. Additionally, each of the plurality of perforations (105) may be described using dimensions such as area, perimeter, etc. Dimensions of each of the plurality of perforations (105) can be measured using any method first described above. Additionally, any one or more of the plurality of perforations (105) can have approximately the same dimensions or different dimensions from another one of the plurality of perforations (105). In various embodiments, any one or more of the plurality of perforations (105) has approximately the same shape and approximately the same dimensions as one another, within a deviation of about 75% or less. In other embodiments, the deviation of the dimensions of each of the plurality of perforations (105) is about 70% or less, about 65% or less, about 60% or less, about 50% or less, about 45% or less, about 40% or less, about 35% or less, about 30% or less, about 25% or less, about 20% or less, about 15% or less, about 10% or less, about 5% or less, or about 1% or less. In various embodiments, all values and ranges of values, both whole and fractional, including and between the aforementioned values, are hereby expressly contemplated for use herein.

The plurality of perforations (105) of the paddle (100) has a total perforated area, calculated by adding the areas of all of the plurality of perforations (105) of the paddle (100), using the one of the methods first described above. The immersible portion (142) of the paddle (100) has a total immersible area, calculated from the dimensions of the paddle (100). The total immersible area includes both the area of the plurality of perforations (105) and the area outside the perforations.

The total perforated area of the plurality of perforations (105) is from about 1 to about 90, about 1 to about 80, about 1 to about 70, about 1 to about 60, or about 1 to about 50% of the total immersible area of the immersible portion (142). Without being bound by theory, it is contemplated that this percentage of the total perforated area to the immersible area allows for the emulsion (162) to migrate across and/or through the plurality of perforations (105), increasing shear and/or elongational flow, thereby achieving effective emulsification of heterogeneous phases resulting in the emulsion (162) with desirable physical performance. In various embodiments, the percentage of the total perforated area as compared to the immersible area is from about 1 to about 50, about 1 to about 40, about 1 to about 30, about 1 to about 20, about 1 to about 10, about 5 to about 45, about 10 to about 40, about 15 to about 35, about 20 to about 30, about 20 to about 25, about 2 to about 9, about 3 to about 8, about 4 to about 7, or about 5 to about 6%. In various embodiments, all values and ranges of values, both whole and fractional, including and between the aforementioned values, are hereby expressly contemplated for use herein.

Each of the plurality of perforations (105) may have an edge that is smooth, e.g. as shown in FIG. 6A, rough, having a wave-like structure and/or a periodic pattern, e.g. sine-wave, sawtooth, etc., e.g. as shown in FIGS. 6B and 6C, or a combination thereof. Edge roughness and/or boundary structure may be evaluated using any method known in the art, including but not limited to standardized methods, e.g. ISO 4287, ASME B46.1, etc., as published in 2025. Edge roughness may be quantified by various metrics, e.g. an arithmetic mean roughness which calculates an average height deviation from a mean height, and/or a maximum height of profile which calculates a sum of highest peak and deepest valley over a sampling length, etc.

In various embodiments, all of the plurality of perforations (105) have an edge that is approximately smooth, e.g. having an arithmetic mean roughness of from about 0 to about 20% of a mean height, alternatively from about 1 to about 10, or about 1 to about 5, % of a mean height. In other embodiments, all of the plurality of perforations (105) has an edge that is approximately rough, e.g. having an arithmetic mean roughness of greater than about 20% of a mean height, alternatively, greater than about 30, greater than about 50, greater than about 70, greater than about 90, % of a mean height. In yet other embodiments, the one or more of the plurality of perforations (105) have an edge that is smooth and one or more of the plurality of perforations (105) have an edge that is rough.

The number of perforations may vary, e.g. from about 2 to about 100. In various embodiments, the number of perforations is from about 2 to about 100, about 5 to about 90, about 10 to about 85, about 15 to about 80, about 20 to about 75, about 25 to about 70, about 30 to about 65, about 35 to about 60, about 40 to about 55, or about 45 to about 50. In other embodiments, the number of perforations is from about 2 to about 20, about 3 to about 19, about 4 to about 18, about 5 to about 17, about 6 to about 16, about 7 to about 15, about 8 to about 14, about 9 to about 13, about 10 to about 12, or about 10 to about 11. In various embodiments, all values and ranges of values, both whole and fractional, including and between the aforementioned values, are hereby expressly contemplated for use herein.

Mixing with the Paddle:

The method further includes the step of mixing with the paddle (100). The step of mixing may also be described as stirring, homogenizing, emulsifying, combining components, e.g. to form the emulsion (162). The step of mixing may be performed manually or automatically, in a batch or continuous manner. The step of mixing may be performed in any order with respect to other steps described above.

The step of mixing may be performed in a single step or multiple steps. In various embodiments, all components included in the emulsions (162) are mixed in a single step process. In other embodiments, the resin and the crosslinker are combined and mixed, followed by the combination and mixing of the water.

FIG. 2 further illustrates one portion of the step of mixing using the paddle (100) shown in FIG. 1. The step of mixing may further include the step of immersing the paddle (100) in the emulsion (162), immersing the entire paddle (100), immersing the immersible portion (142), or immersing the immersible portion (142) and additionally part of the handle portion (140) but not the entire paddle (100), in the emulsion (162). In FIG. 2, a part of the paddle (100) is immersed into the emulsion (162). The part of the paddle (100) immersed in the emulsion (162) may have an area that can be further described as an immersed area. The immersed area may be different from, or approximately the same as, the immersible area. In various embodiments, the immersed area is approximately the same as the immersible area. In other embodiments, the immersed area is different from, i.e. smaller than or larger than, the immersible area. Generally, the efficiency of the step of immersing may be described using an efficiency parameter, which can be calculated using formula (I):

$$( \sum {C}_{P} \times {A}_{NP} ) / {V}_{E} \qquad ( I )$$

wherein ΣC_{P} is a total perimeter of the plurality of perforations (105) that is immersed in the emulsion (162), calculated from one or more dimensions measured by flattening the paddle onto a 2D surface, typically expressed in a unit of cm; A_{NP} is the difference between the immersed area and an immersed perforated area, i.e. an area of the plurality of perforations (105) that is immersed in the emulsion (162), typically expressed in a unit of cm², each calculated from one or more dimensions measured by flattening the paddle (100) onto a 2D surface; and VE is a total volume of the emulsion (162), typically expressed in a unit of cm³. The skilled person appreciates that depending on the shape of one or more of the plurality of perforations (105) and the shape of the paddle (100), one or more mathematical equations may be used to calculate the parameters in formula (I).

It may be appreciated that certain shapes of the plurality of perforations (105) may lead to an exaggeration of the value of the ΣC_{P}, which may be corrected via a process of averaging/smoothening. For example, the edge of the plurality of perforations (105) may exhibit a wave-like structure and/or a periodic pattern with a high frequency, e.g. of at least 10 cycles per perforation, e.g. as shown in FIG. 6C, such that the value of the ΣC_{P} is exaggerated compared to the value of the ΣC_{P} of a smooth perforation having an approximately the same area. As such, in various embodiments, the ΣC_{P} may be calculated by first mathematically smoothening/averaging a boundary data, e.g. to remove irregularities or high-frequency fluctuations of the edge of the plurality of perforations (105). The skilled person appreciates that the smoothing/averaging process can be performed to minimize high-frequency variations or fluctuations in the boundary and can provide a simplified and generalized value for the ΣC_{P} without affecting the overall shape of the plurality of perforations (105). In various embodiments, the smoothing/averaging process is performed using a technique chosen from curve fitting, spline interpolation, Fourier analysis, and combinations thereof. In other embodiments, the smoothing/averaging process is employed to facilitate efficient analysis and/or calculation of geometric properties such as area, volume, or flow dynamics.

In various embodiments, the wave-like structure and/or the periodic pattern has a frequency of at least about 10 cycles per perforation, alternatively at least about 20, at least 50, at least about 100, at least about 500, at least about 1000, cycles per perforation. In other embodiments, the periodic pattern has a frequency of from about 10 to about 1000, about 100 to about 900, about 200 to about 800, about 300 to about 700, about 400 to about 600, about 400 to about 500, about 10 to about 100, about 20 to about 90, about 30 to about 80, about 40 to about 70, about 50 to about 60, about 10 to about 50, about 15 to about 45, about 20 to about 40, about 25 to about 35, or about 25 to about 30, etc., cycles per perforation. In various embodiments, all values and ranges of values, both whole and fractional, including and between the aforementioned values, are hereby expressly contemplated for use herein.

Generally, the parameters in formula (I), e.g. ΣC_{P}, A_{NP}, and V_{E}, may be calculated and/or measured using any method first described above. Typically, the parameters in formula (I) are obtained using the same method to minimize any mathematical or physical errors associated with mathematical modeling, rounding, etc.

The efficiency parameter may be used to mathematically and quantitatively present an interaction between the paddle (100), the plurality of perforations (105) and the emulsion (162), that can facilitate effective mixing. The skilled person appreciates that formula (I) shows that effective mixing may rely on a relationship between the ΣC_{P}, A_{NP}, and V_{E}. Furthermore, the skilled person also appreciates that any paddle (100) may be used, i.e. effective mixing may not depend on the number of perforations, shape, spacing, etc., of each of the plurality of perforations (105), the material of the paddle (100), etc., because these parameters are not present in the calculation of the efficiency parameter.

The efficiency parameter is unitless and may be from greater than about 0 and up to about 100. In various embodiments, the efficiency parameter is from greater than about 0 to about 100, about 0.1 to about 100, about greater than about 0 to about 50, about 0.1 to about 90, about 0.5 to about 80, about 1 to about 70, about 10 to about 60, about 20 to about 50, about 30 to about 40, about 0.1 to about 10, about 1 to about 9, about 2 to about 8, about 3 to about 7, about 4 to about 6, or about 4 to about 5. In various other embodiments, the efficiency parameter is from about 0.1 to about 5, about 0.1 to about 1, about 0.2 to about 0.9, about 0.3 to about 0.8, about 0.4 to about 0.7, or about 0.5 to about 0.6. In various embodiments, all values and ranges of values, both whole and fractional, including and between the aforementioned values, are hereby expressly contemplated for use herein.

The paddle (100) may be immersed into the emulsion (162) at any angle that can facilitate mixing. For example, the emulsion (162) may be held in a container, e.g. a beaker, a bucket, a cup, a tank, etc. such that a fluid surface (160) is formed, as shown in FIG. 2. The paddle (100) may be immersed approximately perpendicular to the fluid surface (160) of the emulsion (162). Alternatively, the paddle (100) may be immersed at an angle (α), measured from the fluid surface (160) of the emulsion (162) of from greater than about 0 to less than about 180°, e.g. about 1° to about 179°, about 10° to about 170°, about 20° to about 160°, about 30° to about 150°, about 40° to about 140°, about 50° to about 130°, about 60° to about 120°, about 70° to about 110°, about 80° to about 100°, about 90° to about 100°. In various embodiments, all values and ranges of values, both whole and fractional, including and between the aforementioned values, are hereby expressly contemplated for use herein.

In various embodiments, the paddle (100) may be immersed entirely in the emulsion (162), such that the immersed area is the same as the area of the paddle (100). In other embodiments, only the immersible portion (142) of the paddle (100) is immersed in the emulsion (162), and the immersed area is approximately equal to the immersible area. In yet other embodiments, the immersed area is smaller than the immersible area. In still other embodiments, the immersed area is larger than the immersible area (142). In various embodiments, the paddle (100) is partly immersed in emulsion (162), for example of from greater than about 0 and up to less than about 100% of the length (L) of the paddle (100), e.g. about 10 to about 90, about 20 to about 80, about 30 to about 70, about 40 to about 60, or about 40 to about 50%, and the immersed area is different from the area of the immersible portion (142). In various embodiments, all values and ranges of values, both whole and fractional, including and between the aforementioned values, are hereby expressly contemplated for use herein.

The step of mixing may be performed using any mixing motion, and in any or no pattern, e.g. circular, up and down, zigzag, back and forth, sweeping, etc., or using a combination of motions. The step of mixing may be performed at various speeds and or time duration, as deemed appropriate by the skilled person, and may depend on various factors, e.g. total volume of the emulsion, the type of the resin and/or the crosslinker, etc. In various embodiments, the step of mixing is performed using a circular motion and at a rotational speed of from about 10 to about 500 rpm. In other embodiments, the rotational speed is from about 50 to about 450, about 100 to about 400, about 150 to about 350, about 200 to about 300, or about 150 to about 200, rpm. In yet other embodiments, the rotational speed is from about 10 to about 100, about 20 to about 90, about 30 to about 80, about 40 to about 70, or about 50 to about 60, rpm. In various embodiments, all values and ranges of values, both whole and fractional, including and between the aforementioned values, are hereby expressly contemplated for use herein.

The step of mixing may be performed for various time durations, typically from about 10 to about 1000 s. In various embodiments, the step of mixing is performed at a time duration of from about 10 to about 1000, about 100 to about 900, about 200 to about 800, about 300 to about 700, about 400 to about 600, or about 400 to about 500, s. In other embodiments, the time duration is from about 10 to about 100, about 20 to about 90, about 30 to about 80, about 40 to about 70, or about 50 to about 60, s. In various embodiments, all values and ranges of values, both whole and fractional, including and between the aforementioned values, are hereby expressly contemplated for use herein.

### Physical Properties of the Emulsion:

The emulsion includes a plurality of hydrophobic droplets, which can be formed naturally when mixing the crosslinker, the resin and the water. Typically, large sized hydrophobic droplets may be indicative of localized spike in amount of the crosslinker and therefore, inefficient emulsification/mixing. In coating applications, large-sized hydrophobic droplets may result in undesirable deviation from standard operation conditions, e.g. longer cure time, high cure temperature, etc., as well as undesirable appearance, e.g. presence of popping formation and/or other surface defects. Accordingly, the emulsion includes hydrophobic droplets having a particle size distribution. The particle size of the hydrophobic droplets may be measured using any method known in the art. For example, the particle size may be determined using a particle analyzer, a light scattering technique, an imaging technique, an electron microscopy technique, e.g. TEM, SEM, cryo-TEM, etc., a fluorescent microscopy technique, etc., or combinations thereof. In various embodiments, the size of the hydrophobic droplets is determined using an optical microscope. For example, the emulsion may be applied to a glass plate by an 8-mil gap drawdown bar, air dried for 24 hours, then evaluated by an optical microscope, e.g. Zeiss Axio Vert A1 Microscope. Images captured under the optical microscope can be analyzed using an imaging software, e.g. ImageJ, to obtain an average diameter of the hydrophobic droplets. In various embodiments, the hydrophobic droplets have a particle size distribution Dv90, obtained using the aforementioned method, that is equal to or less than about 50 microns. In various embodiments, the particle size distribution Dv90 is from greater than about 0 to about 50, about 1 to about 45, about 5 to about 40, about 10 to about 35, about 15 to about 30, or about 20 to about 35, microns. In various embodiments, all values and ranges of values, both whole and fractional, including and between the aforementioned values, are hereby expressly contemplated for use herein.

In the alternative, the droplets may have a Dv10, Dv50, Dv90, Dn10, Dn50, and/or Dn90 particle size each independently as described below, e.g. each independently less than about 50 microns, from greater than about 0 to about 50, about 1 to about 45, about 5 to about 40, about 10 to about 35, about 15 to about 30, or about 20 to about 35, microns, as determined using one or more methods such as ASTM D5861, ISO 13320:2009, ISO 13320:2020, each as published in 2025, or the like. In various embodiments, the Dv10 is from greater than about 0 to about 50, about 1 to about 45, about 5 to about 40, about 10 to about 35, about 15 to about 30, or about 20 to about 35, microns as determined using one or more methods such as ASTM D5861, ISO 13320:2009, ISO 13320:2020, each as published in 2025, or the like. In other embodiments, the Dv50 is from greater than about 0 to about 50, about 1 to about 45, about 5 to about 40, about 10 to about 35, about 15 to about 30, or about 20 to about 35, microns as determined using one or more methods such as ASTM D5861, ISO 13320:2009, ISO 13320:2020, each as published in 2025, or the like. In other embodiments, the Dv90 is from greater than about 0 to about 50, about 1 to about 45, about 5 to about 40, about 10 to about 35, about 15 to about 30, or about 20 to about 35, microns as determined using one or more methods such as ASTM D5861, ISO 13320:2009, ISO 13320:2020, each as published in 2025, or the like. In other embodiments, the droplets may have a Dv10 particle size of is from greater than about 0 to about 50, about 1 to about 45, about 5 to about 40, about 10 to about 35, about 15 to about 30, or about 20 to about 35, microns as determined using one or more methods such as ASTM D5861, ISO 13320:2009, ISO 13320:2020, each as published in 2025, or the like. Alternatively, the droplets may have a Dv10 particle size of is from greater than about 0 to about 50, about 1 to about 45, about 5 to about 40, about 10 to about 35, about 15 to about 30, or about 20 to about 35, microns as determined using one or more methods such as ASTM D5861, ISO 13320:2009, ISO 13320:2020, each as published in 2025, or the like. It is also contemplated that one or more of the Dv10, Dv50, Dv90, Dn10, Dn50, and/or Dn90 particle size measurements may fall outside of the aforementioned ranges. Alternatively, a Dv10, Dv50, Dv90, Dn10, Dn50, and/or Dn90 particle size may be any described above. Moreover, the particle size may be determined using any apparatus known in the art, e.g. a Malvern Mastersizer such as the Mastersizer 3000. Relative to software version, type of light scattering model applied, real and imaginary part of complex refractory index if Mie theory is applied, refractive index, sampling procedure, amount and power of ultrasound, etc. can each be chosen by one of skill in the art if not set forth in the aforementioned standard procedures. The droplets also typically include a weight percent of water (e.g. as absorbed from the atmosphere of less than about 10, 9, 8, 7, 6, 5, 4, 3, 2, 1, 0.5, or 0.1, weight percent based on a total weight of the powder. In various non-limiting embodiments, all values and ranges of values, both whole and fractional, both between and including each of the above, are hereby expressly contemplated for use herein.

In various embodiments, the emulsion, when applied to a glass plate by an 8-mil gap drawdown bar and air dried for 24 hours, is free of popping formation, evaluated by an optical microscope, as first described above.

The emulsion may exhibit various viscosities, typically depending on the type and amount of the resin, crosslinker, and optionally presence of a rheology control agent. Typically, in coating applications, the emulsion can exhibit a viscosity of from about 100 to about 10,000 cP. In various embodiments, the viscosity is from about 100 to about 10,000, about 1000 to about 9000, about 2000 to about 8000, about 3000 to about 7000, about 4000 to about 6000, or about 4000 to about 5000 cP. In other embodiments, the viscosity of the emulsion is from about 100 to about 500, about 150 to about 450, about 200 to about 400, about 250 to about 350, or about 250 to about 300, cP. In yet other embodiments, the viscosity is from about 500 to about 5000, about 600 to about 4500, about 700 to about 4000, about 800 to about 3000, about 900 to about 2000, or about 1000 to about 2000, cP. In various embodiments, all values and ranges of values, both whole and fractional, including and between the aforementioned values, are hereby expressly contemplated for use herein.

The viscosity of the emulsion can be measured using a Brookfield Viscometer, Model CAP2000 at standard conditions of 20° C. and 50% Relative Humidity (RH). The viscometer may be calibrated using hydrocarbon oils of known viscosities, which can vary from 1 to 10,000 cP. A set of RV spindles that attach to the viscometer can be used for the calibration. Measurements of the emulsion can be performed using the No. 4 spindle at a speed of 400 rpm until the viscometer equilibrates. The viscosity corresponding to the equilibrium reading is then calculated using the calibration.

The emulsion can provide customizable coating performance, which may be described using metrics such as Fisher hardness, fingerprint hardness, fingernail hardness, distinctness of Image (DOI), glossiness, etc. In various embodiments, the emulsion is applied on a surface of a substrate to form a coating. In various embodiments, the emulsion is applied on and in direct contact with the surface of the substrate. In other embodiments, the emulsion is applied on and not in direct contact with the substrate, e.g. as a middle layer or as a top layer of coating. The coating formed from applying the emulsion may be baked, e.g. to form a dried coated substrate. In various embodiments, the coating is dried at a temperature of about 50 to about 150, about 55 to about 145, about 60 to about 140, about 65 to about 135, about 70 to about 130, about 75 to about 125, about 80 to about 120, about 85 to about 115, about 90 to about 110, about 95 to about 105, about 90 to about 100, or about 90 to about 95° C. and in a time period of from about 1 to about 30, about 5 to about 25, about 10 to about 20, or about 15 to about 20, minutes. In various embodiments, all values and ranges of values, both whole and fractional, including and between the aforementioned values, are hereby expressly contemplated for use herein.

In various embodiments, longevity and resistance to wear of the emulsion is determined using a Fisher hardness test, which may be performed using any method known in the art. In various embodiments, the Fisher hardness is determined according to ASTM E384, as published in 2025. In other embodiments, the Fisher hardness is determined using a micro-indentation hardness tester, such as the Fisher Scope HM2000, using any indenter, e.g. Vickers pyramid-shaped diamond, spherical indenter, etc. The Fisher hardness may be determined at various points in coating processes as deemed appropriate by the skilled person. Typically, the Fisher hardness is measured after baking, e.g. about 1 hour after baking, about 2 hours after baking, about 3 hours after baking, about 4 hours after baking, about 5 hours after baking, about 1 day after baking, etc. In various embodiments, all values and ranges of values, both whole and fractional, including and between the aforementioned values, are hereby expressly contemplated for use herein.

The Fisher hardness of the emulsion can be at least about 10% greater than the Fisher hardness of a comparative product that is formed by mixing with a comparative paddle that is free of the plurality of perforations, measured according to ASTM E384. In various embodiments, the Fisher hardness is at least about 10% greater, about 15% greater, about 20% greater, about 30% greater, about 40% greater, about 50% greater, about 60% greater, about 70% greater, about 80% greater, about 90% greater, about 100% greater than the Fisher hardness of a comparative product. In various embodiments, all values and ranges of values, both whole and fractional, including and between the aforementioned values, are hereby expressly contemplated for use herein.

The emulsion can also improve glossiness of the surfaces of substrates, which can be measured using various techniques in the art. For example, a wave-scan may be used simulate visual perception, e.g. by using a Wavescan-DOI instrument from BYK-Gardner GmbH. The instrument can provide a laser point light source which can illuminate the surface of the substrate at various angles, e.g. about 10°, about 20°, about 30°, about 40°, about 50°, about 60°, about 70°, about 85°, etc., angle. An associated detector can be used to measure light intensity reflected at an equal but opposite angle. Longwave signal (structure size >0.6 mm) and shortwave signal (structure size <0.6 mm) can each be divided from the measured signal using a mathematical filter function. A meter can then be rolled across the surface and measured, point-by-point, an optical profile of the surface across a defined distance, wherein a result of “0” describes a lowest possible variance, which can be desirable for glossy surfaces, and “100” describes a highest possible variance, which may indicate severe surface defects.

In various embodiments, the glossiness of the surface coated with the emulsion, measured at any angle and method described above, is from about 80 to about 100. In other embodiments, the glossiness is from about 85 to about 100, about 80 to about 90, about 85 to about 100, or about 90 to about 100. In various embodiments, all values and ranges of values, both whole and fractional, including and between the aforementioned values, are hereby expressly contemplated for use herein.

The emulsion can also improve how crisp and sharply a reflected image appears on the surface of the substrate, also described as a distinctness of image (DOI). The DOI may be measured using any method known in the art. In various embodiments, the DOI is measured according to ASTM D5767-18, as published in 2025. Typically, the DOI is evaluated on a scale of 0 to 100, wherein a higher rating indicates more image sharpness, which is typically desirable in coating applications.

In various embodiments, the DOI of the surface coated with the emulsion, measured according to ASTM D5767-18, is from about 80 to about 100. In other embodiments, the glossiness is from about 85 to about 100, about 80 to about 90, about 85 to about 100, or about 90 to about 100. In various embodiments, all values and ranges of values, both whole and fractional, including and between the aforementioned values, are hereby expressly contemplated for use herein.

### EXAMPLES

Various emulsions were formed by mixing resins, crosslinkers, and additional components using different perforated and non-perforated mixers, as set forth in the Examples below.

### Example I

A combination of 56 parts of part A, 23 parts of part B, each as set forth in Table 1 and 21 parts of water were used to form a first series of emulsions. The step of mixing part B with part A, i.e. an activation step, was performed for either 45 or 90 seconds. Subsequently, water was added to the part A and part B mixture, i.e. reduction step, which was performed for either 40 or 60 seconds. The emulsion was sprayed onto a waterborne sealer and a waterborne metallic basecoat-coated e-coat panel and a glass panel, forming a coated surface. The coatings were baked at 60° C. for 30 min.

TABLE 1
Components included in the emulsions of Example I.

| Component | (parts by weight) |
|---|---|
| Part A (the resin) | |
| Acrylic Copolymer Dispersion | 83.41 |
| Polyester Example B | 5.53 |
| 2-Ethylhexane-1,3-diol | 2.05 |
| Propylene Glycol Methyl Ether | 1.33 |
| Butyl glycol acetate | 0.51 |
| Mineral Spirits | 1.63 |
| N,N-dimethylethanolamine | 0.14 |
| Deionized Water | 4.61 |
| Byk 345 | 0.59 |
| Byk 333 | 0.19 |
| Total Weight of Part A | 100 |
| Part B (the crosslinker) | |
| Desmodur ®N 3900 | 47.3 |
| Bayhydur XP2655 | 23.8 |
| Butyl glycol acetate | 28.9 |
| Total Weight of Part B | 100 |

BYK® 345 is silicone surfactant, available from Altana.

BYK® 333 is silicone-containing surface additive, available from Altana.

Bayhydur XP2655 is hydrophilic aliphatic polyisocyanate based on hexamethylene diisocyanate (HDI), available from Covestro AG.

Desmodur® N 3900 is hexamethylenediisocyanate trimer, available from Covestro AG.

The acrylic copolymer dispersion and the polyester were synthesized according to procedures as set forth below.

### Synthesis of the Acrylic Copolymer Dispersion:

In a reactor equipped with a propeller-type stirrer, a thermometer, condenser and monomer/initiator feeding system, 385 grams of CE10P (CE10P is Cardura E10P: versatic acid glycidylester, available from Hexion) and 75 grams of ethoxypropanol were loaded and heated to about 150° C. A mixture of 103 grams of hydroxyethylmethacrylate, 217 grams of styrene, 136 grams of acrylic acid, 250 grams of isobornyl methacrylate, 18 grams of dicumylperoxide, 77 grams of CE10P and 88 grams of ethoxypropanol were added over 2.5 hours to the reactor whilst maintaining the contents at 150° C. After the feed, the reactor contents were held for 30 minutes.

After this hold period, 170 grams of hydroxyethylmethacrylate, 47.5 grams of acrylic acid, 222 grams of isobutyl methacrylate (IBMA), 7.3 grams of dicumylperoxide and 102 grams of ethoxypropanol were added over 2.5 hours whilst maintaining the contents at 150° C. This addition was followed by a rinsing step for the feed system using 58 grams of ethoxypropanol. After the rinsing step, the contents of the reactor were held for 2 hours at 150° C.

The reactor contents were cooled to 100° C. and 190 grams of ethoxypropanol were distilled off. 52 grams of dimethylaminoethanol (DMEA) were added to the contents, after which the obtained polymer blend was diluted with 1805 grams of water preheated to about 70° C.

The measured properties of the obtained dispersion were as follows: solids content, 45.1 wt. %; viscosity, 3800 centipoise; acid value, 27.8 mg KOH/g; and, pH, 7.8. In a visual determination of stability, the obtained aqueous dispersion demonstrated 4 weeks without sedimentation when stored at 60° C.

The molecular weights of the synthesized copolymer, as determined by gel permeation chromatography (GPC) using polystyrene calibration standards in accordance with ASTM 3536 were number average molecular weight (Mn) of 4300 Daltons; and weight average molecular weight (Mw) of 16600 Daltons.

### Synthesis of the Polyester Example B:

A mixture of 911 g of trimethylol propane, 748 g of hexahydrophthalic anhydride and 138 g of dimer fatty acid (EmpolS 1008 from Henkel EmpolS) was heated to 250° C. Esterification was carried out with water separation until an acid value of less than 5 mg KOH/g was obtained. After the reaction mixture was cooled to below 125° C., the solids content was adjusted to 70 wt. % with 90 g of xylene and 641 g of methoxypropyl acetate.

The obtained polyester polyol had a calculated hydroxyl value of 345 mg KOH/g and an acid value of 4.5 mg KOH/g. The calculated hydroxyl functionality was 5.6 and the calculated number average molecular weight (Mn), as determined by gel permeation chromatography (GPC) using polystyrene calibration standards in accordance with ASTM 3536, was 920 Daltons.

### Mixing of Part A and Part B

Part A and part B as set forth in Table 1 were mixed using various perforated and non-perforated mixers (Perforated Mixer 1, Perforated Mixer 2, Non-perforated Mixer 3) to form the first series of emulsions.

Perforated Mixer 1, which is an inventive example of a paddle of this disclosure, was commercially obtained under the tradename Turbomix™ Paddles XL, and Perforated Mixer 2, another inventive example, was commercially obtained under the tradename Turbomix™ Paintsaver™ Paint Stirrer, both obtained from Colad. Non-perforated Mixer 3, which is a comparative example, was a regular paint stir stick commercially obtained from Uline.

Coating performance for each of the emulsions in the first series were examined and recorded in Table 2. Under approximately the same mixing conditions, i.e. at a rotational speed of about 175 rpm, mixing time, and reduction time, all metrics in Table 2 show either comparable or improved performance when a perforated mixer was used, over a non-perforated mixer.

TABLE 2
Coating Performance of the emulsions of Example I.

| | | | | 3 hr | | | |
|---|---|---|---|---|---|---|---|
| | | | | Fischer | | | Gloss |
| | Efficiency | Mixing | Reduction | Hardness | Pop | | at |
| Mixer | Parameter | Time (s) | Time (s) | (Mpa) | Rating | DOI | 20° |
| Perforated | 0.46 | 45′ | 40′ | 13.75 | 5.5 | 85 | 86.1 |
| Mixer 1 | | | | | | | |
| Perforated | 0.33 | 45′ | 40′ | 8.85 | 4.75 | 85 | 85.7 |
| Mixer 2 | | | | | | | |
| Non- | 0 | 45′ | 40′ | 5.75 | 5 | 84 | 85.3 |
| perforated | | | | | | | |
| Mixer 3 | | | | | | | |
| Perforated | 0.46 | 90′ | 60′ | 14.25 | 4.75 | 86 | 89.9 |
| Mixer 1 | | | | | | | |
| Perforated | 0.33 | 90′ | 60′ | 9.4 | 4.5 | 85 | 84.9 |
| Mixer 2 | | | | | | | |
| Non- | 0 | 90′ | 60′ | 5.1 | 4 | 86 | 85.9 |
| perforated | | | | | | | |
| Mixer 3 | | | | | | | |

Various coating performance metrics of the emulsions were tested. For example, Fischer hardness of the emulsions applied on a glass surface was measured at 3 hours after baking, according to ASTM 384, as published in 2025. Pop ratings of the coatings on e-coat panels were evaluated based on the densities of the pops. A rating of 6 means no popping defect. Distinctness of image (DOI) was also assessed the following day after the step of baking, which can indicate the clarity and sharpness of the coated surface. The DOI was measured using Wavescan-DOI from BYK-Gardner GmbH. A high number of DOI can indicate a coated surface with desirable coating sharpness, i.e. with minimal or no distortion. Additionally, glossiness of the coated surface, measured using a Gloss meter from BYK-Gardner GmbH, at a 20-degree angle of incidence. A high glossiness is typically desirable for coating. More specifically, Fisher hardness, DOI and Gloss performance were improved when using either Perforated Mixer 1 or 2, over Non-perforated Mixer 3, at either short mixing and reduction time (45 s of mixing and 40 s of reduction), or long mixing and reduction time (90 s of mixing and 60 s of reduction). Therefore, the perforated mixers are assessed by efficiency parameter. Additionally, pop rating was improved when using the Perforated Mixer 1, at either mixing and reduction condition, and further improved by using the Perforated Mixer 2 at the long mixing and reduction condition.

Particle size distribution of hydrophobic droplets was not measured in this Example.

### Example II

A combination of 63 parts of part A, 21 parts of part B, each as set for the in Table 3 and 16 parts of water were used to form a second series of emulsions. The step of mixing part B with part A, i.e. an activation step, was performed for about 30 seconds and at a rotational speed of about 175 rpm. Subsequently, water was added to the part A and part B mixture, i.e. reduction step, which was performed for 30 seconds and at a rotational speed of about 175 rpm. The acrylic copolymer dispersion, Byk 345, Byk 333 are as described in Example I.

TABLE 3
Components included in the emulsions of Example II.

| Component | Percentage |
|---|---|
| Part A (the resin) | |
| Acrylic Copolymer Dispersion | 62.6% |
| Propylene Glycol Methyl Ether | 4.3% |
| Mineral Spirits | 0.7% |
| Byk 345 | 0.4% |
| Byk 333 | 0.1% |
| Deionized Water | 7.2% |
| Total Weight of Part A | 75.3% |
| Part B (the crosslinker) | |
| Butyl Glycol Acetate | 10.4% |
| Hexamethylene Diisocyanate trimer (HDI | 14.2% |
| trimer) | |
| Total Weight of Part B | 24.7% |
| Deionized Water | 100.0% |

### Mixing of Part A and Part B

Part A and part B as set forth in Table 3 were mixed using Perforated Mixer 2, which is an inventive example, and Non-perforated Mixer 3, which is a comparative example, as described in Example I, to form the second series of emulsions.

The emulsion was sprayed onto a waterborne sealer and a waterborne metallic basecoat-coated e-coat panel to form a coated surface and achieve a dry film thickness, as indicated in Table 5. The coatings were baked at 60° C. for 30 min. Fingerprint (thumb print) and fingernail (thumbnail) hardness were measured at 1 hour after baking on the coated surface with the dry film thickness of about 50 microns. The fingerprint hardness test was performed by applying pressure of a thumb print to the coated surface and observing how much a print is created and how quickly the coated surface recovers. The score is ranked from 3 to 6, where 3 describes a medium print, i.e. having a diameter of from about 50 to about 80 microns, with a slow recovery, and 6 describes no print observed. A score of 4 describes a medium print and fast recovery, and a score of 5 describes a shallow print and fast recovery. Additionally, a fingernail hardness test was performed by applying a thumbnail press to observe how deep an indent is created. The score is ranked from 3 to 6, where 3 describes a medium indent, i.e. having a diameter of from about 50 to about 80 microns, and 6 describes no indent. A score of 4 describes a shallower indent than 3, and a score of 5 describes a further shallower print than 4. The scores recorded in Table 4 indicate that both fingerprint and fingernail hardness were improved when using a perforated Mixer compared to a non-perforated Mixer.

TABLE 4
Coating Performance of the emulsions of Example II.

| | | 1 h | 1 h |
|---|---|---|---|
| | Efficiency | Fingerprint | Fingernail |
| Mixer | Parameter | Hardness | Hardness |
| Non-perforated | 0 | 4 | 4.25 |
| Mixer 3 | | | |
| Perforated | 0.33 | 4.25 | 4.5 |
| Mixer 2 | | | |

The DOI of the coated surface was also tested for a variety of dry film thickness, as set forth in Table 5. Results in Table 5 show that at all dry film thicknesses, the DOI of the coated surface either improved or remained constant when using a perforated mixer compared to a non-perforated mixer.

TABLE 5
DOI of the emulsions of Example II at
varying dry film coating thickness.

| Coating Thickness (microns) | 50 | 62 | 75 |
|---|---|---|---|
| Non-perforated Mixer 3 | 84 | 87 | 88 |
| Perforated Mixer 2 | 85 | 87 | 90 |

Particle size distribution of hydrophobic droplets was not measured in this Example.

### Example III

A third series of emulsions was formed by combining 32.6 g of part B and 87.4 g of part A, as set forth in Table 1. The step of mixing was performed with various paddles, e.g. various sizes and quantities of perforations, as set forth in Table 6 (Perforated Mixer 4-6, i.e. inventive examples, and Non-perforated Mixer 7, i.e. a comparative example). The mixing speed was maintained at 170-185 rpm during the step of mixing and performed for a time duration of 45 s. No reduction/dilution (combining with water) was performed.

Non-perforated Mixer 7 was a stirring mixer obtained from Uline. Perforated Mixers 4 to 6 were derived from Mixer 7, i.e. circular perforations were drilled into Non-perforated Mixer 7, to form a specific number of perforations, each with a specific diameter, and spacing between perforations, as specified in the Table 6 below.

The emulsion was applied to a glass plate by an 8-mil gap drawdown bar, air dried for 24 hours. The emulsification performance was evaluated by an optical microscope Zeiss Axio Vert A1 Microscope. Images taken from the optical microscope were analyzed ImageJ software, to estimate an average hydrophobic droplet diameter, recorded in Table 6 below.

TABLE 6
Hydrophobic Droplet Size of the emulsions of Example I.

| Mixer | 4 | 5 | 6 | 7 |
|---|---|---|---|---|
| Perforation | 0.35 | 0.35 | 0.5 | — |
| Diameter (cm) | | | | |
| Amount of | 5 | 9 | 5 | — |
| Perforations | | | | |
| Immersed | | | | |
| Vertical | 0.8 | 0.4 | 0.65 | — |
| Spacing | | | | |
| Between | | | | |
| Centers of | | | | |
| Perforations | | | | |
| (cm) | | | | |
| Efficiency | 0.39 | 0.67 | 0.53 | 0 |
| Parameter | | | | |
| Hydrophobic | 30 ± 5.6 | Not | 20 ± 5.1 | 34 ± 6.8 |
| Droplet Size | | visible | | |
| (mm) | | | | |

Results set forth in Table 6 show that, compared to a non-perforated mixer, i.e. Non-perforated mixer 7, Perforated mixers 4-6 resulted in emulsions that included smaller hydrophobic droplets. Furthermore, perforated mixer 5 generated hydrophobic droplets that were too small to detect using the optical microscope. Small or non-visible droplets can indicate effective mixing, which can be beneficial in obtaining desirable coating performance, such as those described in Tables 2 and 4. The method provided in this disclosure results in emulsions that are clearly superior to and expected over, emulsions obtained by using conventional methods.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method of forming an emulsion (162), said method comprising the steps of:
a. providing a resin having a cross-linkable group;
b. providing a crosslinker;
c. providing water;
d. providing a paddle (100) having an immersible portion (142) defining a plurality of perforations (105); wherein
the immersible portion (142) of the paddle (100) has an immersible area, measured by flattening the paddle (100) onto a 2-dimensional surface;
the plurality of perforations (105) has a total perforated area, measured by flattening the paddle (100) onto a 2-dimensional surface; and
the total perforated area of the plurality of perforations (105) is from about 1 to about 50% of the immersible area of the immersible portion (142); and
e. mixing the resin, the crosslinker; and the water with the paddle (100) to form the emulsion (162) wherein the emulsion (162) comprises a plurality of hydrophobic droplets having a particle size distribution Dv90 of equal to or less than about 50 microns, assessed using an optical microscope.

2. The method of claim 1 wherein the resin is chosen from a hydroxyl-functional (meth)acrylic, a latex copolymer, and combinations thereof.

3. The method of claim 1 wherein the resin is present in the emulsion (162) in an amount of from about 20 to about 90 wt % actives, based on a total weight of the emulsion (162).

4. The method of claim 1 wherein the crosslinker is chosen from an isocyanate crosslinker, a melamine crosslinker, an amine crosslinker, and combinations thereof.

5. The method of claim 1 wherein the crosslinker is an isocyanate crosslinker.

6. The method of claim 1 wherein the crosslinker is present in the emulsion (162) in an amount of from about 5 to about 50 wt % actives, based on a total weight of the emulsion (162).

7. The method of claim 1 wherein the emulsion (162) further comprises an additional component chosen from a catalyst; a stabilizer; a wetting agent; a rheology control agent; a pigment; a solvent; and combinations thereof.

8. The method of claim 1 wherein the step of mixing further comprises the step of immersing a part of the paddle (100) into the emulsion (162) such that an efficiency parameter, calculated using formula (I), is from greater than about 0 and up to about 50;
$$( \sum {C}_{P} \times {A}_{NP} ) / {V}_{E} \qquad ( I )$$
wherein ΣC_{P} is a total perimeter of the plurality of the perforations (105) that is immersed in the emulsion (162), measured by flattening the paddle (100) onto a 2-dimensional surface;
A_{NP} is the difference between an immersed area of the paddle (100) and a total immersed perforated area of the plurality of perforations (105); each measured by flattening the paddle (100) onto a 2-dimensional surface, and
V_{E} is a total volume of the emulsion (162).

9. The method of claim 8 wherein the efficiency parameter is from about 0.1 to about 5.

10. The method of claim 8 wherein the immersed area is equal to or less than the immersible area of the immersible portion (142).

11. The method of claim 1 wherein the step of mixing is performed at a rotational speed of from about 10 to about 500 rpm.

12. The method of claim 1 wherein the step of mixing is performed for a time duration of from about 10 to about 1000 s.

13. The method of claim 1 wherein the total perforated area of the plurality of perforations (105) is from about 1 to about 30% of the immersible area of the immersible portion (142).

14. The method of claim 1 wherein the immersible portion (142) of the paddle (100) has a length (L) and a width (W) and the ratio of the length (L) to the width (W) is from about 1:1 to about 100:1.

15. The method of claim 1 wherein the immersible portion (142) of the paddle (100) has a thickness (T) of from about 0.5 to about 100 mm.

16. The method of claim 1 wherein the plurality of hydrophobic droplets having a particle size distribution Dv90 of equal to or less than about 30 microns, assessed using an optical microscope.

17. The method of claim 1 wherein the emulsion (162) exhibits a Fisher hardness that is at least about 10% greater than the Fisher hardness of a comparative product that is formed by mixing with a comparative paddle that is free of the plurality of perforations, measured according to ASTM E384.

18. The method of claim 1 wherein the emulsion (162), when applied to a glass plate by an 8-mil gap drawdown bar and air dried for 24 hours, is free of popping formation, assessed using an optical microscope.

19. A method of forming an emulsion (162), said method comprising the steps of:
a. providing a resin from a hydroxyl-functional (meth)acrylic, a latex copolymer, and combinations thereof,
b. providing a crosslinker chosen from an isocyanate crosslinker, a melamine crosslinker, an amine crosslinker, and combinations thereof,
c. providing water;
d. providing a paddle (100) having an immersible portion (142) defining a plurality of perforations (105); wherein
the immersible portion (142) of the paddle (100) has an immersible area, measured by flattening the paddle (100) onto a 2-dimensional surface;
the plurality of perforations (105) has a total perforated area, measured by flattening the paddle (100) onto a 2-dimensional surface; and
the total perforated area of the plurality of perforations (105) is from about 1 to about 20% of the immersible area of the immersible portion (142); and
e. mixing the resin, the crosslinker; and the water with the paddle (100) to form the emulsion (162) wherein the emulsion (162) comprises a plurality of hydrophobic droplets having a particle size distribution Dv90 of equal to or less than about 50 microns, assessed using an optical microscope.

20. A method of forming an emulsion (162), said method comprising the steps of:
a. providing a resin comprising a hydroxyl-functional (meth)acrylate copolymer;
b. providing a crosslinker comprising a polyisocyanate compound having pendant —NCO groups;
c. providing water;
d. providing a paddle (100) having an immersible portion (142) defining a plurality of perforations (105); wherein
the immersible portion (142) of the paddle (100) has an immersible area, measured by flattening the paddle (100) onto a 2-dimensional surface;
the plurality of perforations (105) has a total perforated area, measured by flattening the paddle (100) onto a 2-dimensional surface; and
the total perforated area of the plurality of perforations (105) is from about 1 to about 20% of the immersible area of the immersible portion (142); and
e. mixing the resin, the crosslinker; and the water with the paddle (100) to form the emulsion (162) wherein the emulsion (162) comprises a plurality of hydrophobic droplets having a particle size distribution Dv90 of equal to or less than about 50 microns, assessed using an optical microscope.
